(19) United States
(12) Patent Application Publication
(10) Pub. No.: US 2022/0259238 A1
(43) Pub. Date: Aug. 18, 2022

(54) METHOD FOR PRODUCING ORTHO-METALLATED METAL COMPOUNDS

(71) Applicant: Merck Patent GmbH, Darmstadt (DE)

(72) Inventor: Philipp STOESSEL, Frankfurt am Main (DE)

(21) Appl. No.: 17/628,661

(22) PCT Filed: Jul. 20, 2020
(86) PCT No.: PCT/EP2020/070397

§ 371 Date: Jan. 20, 2022

(30) Foreign Application Priority Data
Jul. 22, 2019 (EP) 19187468.4

(51) Int. Cl. C07F 15/00

(52) U.S. Cl. CPC C07F 15/0033

(57) ABSTRACT

The present invention relates to a method for producing cyclo-metallated metal compounds which, in their capacity as functional materials, are used as colouring components in a range of diverse applications attributable in the widest sense to the electronics industry.

The present invention relates to a process for preparing cyclometalated iridium compounds from simple iridium reactants.

Organometallic iridium compounds are used as functional materials in a number of different applications that can be broadly attributed to the electronics industry, especially as phosphorescent emitters in organic electroluminescent devices. This requires efficient synthetic access to the corresponding high-purity iridium compounds. This is of crucial importance for the resource-conserving use of this class of compounds, taking account of the scarcity of Ir.

Various processes are known for the preparation of cyclometalated organoiridium compounds. Common factors in these are that they are performed in organic solvents or mixtures of organic solvents with water, frequently at high temperatures and with long reaction times. When chlorine-containing iridium reactants are used, silver salts are frequently used here for elimination of the chloride, but this leads to problems in the purification of the iridium complexes. Therefore, the use of silver salts is undesirable.

For example, there are known processes in the melt with high-melting protic compounds, for example hydroquinone, phenol, naphthol, resorcinol, catechol, polyethylene glycol and mixtures thereof. These compounds have been found to be good reaction media especially for cyclometalation reactions with polypodal ligands (for example according to WO 2016/124304) or else corresponding dinuclear complexes (for example according to WO 2018/041769). The ortho-metalation reactions, above 240° C. in the melt, proceed quickly, selectively and without apparent side reactions. The removal of the water- and alcohol-soluble reaction medium is excellent, since the reaction product is insoluble in these media. Thus, in laboratory operation, the reaction can be performed in very good space-time yield. By contrast, it is found to be technically difficult to upscale this process in batchwise reactor operation on the production scale, since it is technically very difficult to heat up relatively large volumes quickly and without overheating to the required temperature of >240° C., or to cool them back down again after the reaction. Moreover, it is found to be disadvantageous that the reaction mixture solidifies as it cools, which leads to problems with stirring and workup. An additional factor is specific safety requirements in such a high-temperature process, which in practice leads to very high demands on the plants and building infrastructure, for example separate buildings owing to large ex zones (explosion hazard zones). Moreover, in the upscaling of the process, the formation of pyrophoric iridium is observed in some cases, which can lead to self-ignition when the crude product is sucked dry under air and hence constitutes a considerable safety risk. Therefore, improvements are still desirable here.

The problem underlying the present invention is therefore that of providing a broadly applicable process by which cyclometalated iridium complexes, especially polypodal cyclometalated iridium complexes, and corresponding polynuclear complexes can be synthesized in a simple manner and in high yield from readily obtainable iridium reactants, for example iridium(III) halide hydrate or iridium(III) acetate, under mild conditions and in good yield. It is a particular problem to provide a broadly applicable process for synthesis of polypodal cyclometalated complexes and corresponding polynuclear complexes, wherein the addition of silver salts is to be avoided. In addition, no pyrophoric by-products are to be formed in the process. In addition, the reactants and reaction media were to be non-toxic and of good commercial availability. A further problem addressed by the present invention is that of providing a process which can proceed not only from iridium halide but also from halogen-free, especially chlorine-free, reactants, since reaction in that case is also possible in stainless steel reactors, whereas the reaction in the case of use of chlorine-containing reactants should be performed in inert reactors, for example of glass or enamel.

It has been found that, surprisingly, the synthesis of cyclometalated iridium complexes proceeding from various iridium(III) or iridium(I) reactants, for example iridium halide, iridium acetate or other iridium reactants, can be performed in an anhydrous organic carboxylic acid in high yields and purities. The reaction here proceeds under comparatively mild conditions, i.e. at temperatures<190° C. and low pressure.

The present invention therefore provides a process for preparing a cyclometalated iridium complex by reacting an iridium compound with one or more ligands that coordinate to the iridium under cyclometalation, characterized in that the process is conducted in anhydrous medium in the presence of a carboxylic acid.

A cyclometalated iridium complex in the context of the present invention is an iridium complex which has at least one bidentate cyclometalated ligand or subligand. The iridium complex here may be mononuclear or polynuclear, for example dinuclear or trinuclear. It is preferably a tris-cyclometalated iridium complex having three bidentate cyclometalated ligands or subligands. In the context of the present invention, the term “cyclometalated iridium complex” also includes iridium complexes in which the three bidentate ligands, at least one of which is cyclometalated, are covalently bonded to one another via a bridge, so as to form either a tripodal hexadentate ligand. The same is true of polynuclear complexes. In the context of the present invention, a cyclometalated ligand is a ligand which forms a metallacycle with the metal to which it coordinates, with at least one metal-carbon bond being present between the ligand and the metal.

Depending on ligands, either homoleptic or heteroleptic metal complexes can be synthesized. A homoleptic complex is understood to mean a compound in which only identical ligands are bonded to a metal. Heteroleptic complexes are those in which different ligands are bonded to the metal. This relates both to ligands with different ligand base structure and to ligands which have the same base structure but are substituted differently.

In a preferred embodiment of the invention, the cyclometalated iridium complex is a homoleptic complex when the three bidentate ligands are not joined covalently via a bridge to form a hexadentate tripodal ligand. When the three bidentate ligands are covalently bonded via a bridge to form a hexadentate tripodal ligand, preference is equally given to complexes in which the individual bidentate subligands of the tripodal ligand differ from one another.

In a further preferred embodiment of the invention, the cyclometalated iridium complex is the facial isomer of the complex. Facial or meridional coordination in the context of this application describes the octahedral environment of the iridium with the six donor atoms. Coordination is facial when three identical donor atoms occupy a triangular surface in the (pseudo)octahedral coordination polyhedron and three identical donor atoms other than the first donor atoms occupy another triangular surface in the (pseudo)octahedral coordination polyhedron. In the case of meridional coordination, three identical donor atoms occupy one meridian in the (pseudo)octahedral coordination polyhedron and three identical donor atoms other than the first donor atoms occupy the other meridian in the (pseudo)octahedral coordination polyhedron. This is shown below by the example of the coordination of three donor nitrogen atoms and three donor carbon atoms (scheme 1). Since this definition refers to donor atoms and not to the bidentate ligands that provide these donor atoms, the three bidentate cyclometalated ligands may be the same or different and nonetheless conform to facial or meridional coordination in the context of this application. Identical donor atoms are understood to mean those which consist of the same elements (e.g. carbon or nitrogen), irrespective of whether these elements are incorporated into different structures.

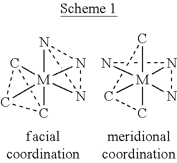

The iridium complex obtainable by the process of the invention preferably has a structure of the following formula (1), (2) or (3):

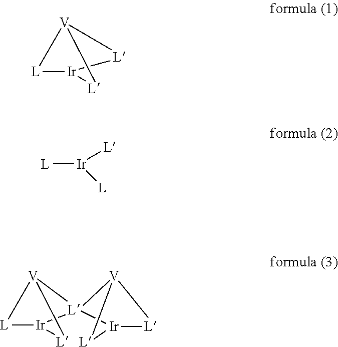

in which:
L is the same or different at each instance and is a bidentate cyclometalated ligand in formula (2) or a bidentate cyclometalated subligand in formulae (1) and (3);
L′ is the same or different at each instance and is a bidentate ligand in formula (2) or a bidentate subligand in formulae (1) and (3);
L″ is a bis(bidentate) cyclometalated subligand that coordinates to both iridium atoms;
V is the same or different at each instance and is a bridging unit which, in formula (1), joins the subligands L and L′ to one another to form a tripodal hexadentate ligand and, in formula (3), joins the subligands L′ and L″ to one another to form a dodecadentate ligand overall.

The ligand used in the process of the invention, for complexes of the formula (1), corresponds to the compound of the formula (4),

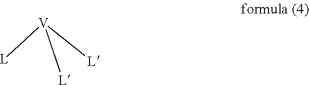

where the symbols have the definitions given above and the subligand L has a carbon-hydrogen bond rather than the carbon-iridium bond, and the subligands L′ have a hydrogen atom rather than a bond to the iridium.

The ligands used in the process of the invention, for complexes of the formula (2), correspond to L and L′, where the ligand L has a carbon-hydrogen bond rather than the carbon-iridium bond and the ligand L′ has a hydrogen atom rather than a bond to the iridium.

The ligand used in the process of the invention, for complexes of the formula (3), corresponds to the compound of the formula (5),

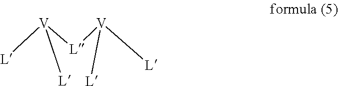

where the symbols have the definitions given above and the subligand L″ has carbon-hydrogen bonds rather than the carbon-iridium bonds, and the subligands L′ have a hydrogen atom rather than the bond to the iridium.

The bidentate ligand or subligand L′ here may be cyclometalated or non-cyclometalated, and L and L′ in formulae (1) and (2) may also be the same when L′ is a cyclometalated ligand.

In a preferred embodiment of the invention, L and L′ are monoanionic ligands, and L″ is a dianionic ligand.

The ligand of the formula (4) in complexes of the formula (1) is a hexadentate tripodal ligand with three bidentate subligands L and L′ that may be the same or different. “Bidentate” means that the particular subligand in the complex coordinates or binds to the iridium via two coordination sites. “Tripodal” means that the ligand has three subligands bonded to the bridge V. Since the ligand has three bidentate subligands, the overall result is a hexadentate ligand, i.e. a ligand which coordinates or binds to the iridium via six coordination sites. The expression “bidentate subligand” in the context of this application means that L and L′ would each be a bidentate ligand if the bridge V were absent. However, as a result of the formal abstraction of a hydrogen atom from this bidentate ligand and the attachment to the bridge V, it is no longer a separate ligand but a portion of the hexadentate ligand which thus arises, and so the term “subligand” is used therefor.

The ligand of the formula (5) in complexes of the formula (3) is a dodecadentate bis(tripodal) ligand that coordinates to two iridium atoms. The ligand here contains two bidentate subligands L′ that each coordinate to one of the two iridium atoms in each of the two halves, and contains a bis(bidentate) subligand L″ that coordinates to both iridium atoms.

In a preferred embodiment of the invention, the ligands L′ are bidentate cyclometalated ligands or subligands. The metal complexes obtainable by the process of the invention therefore preferably have the structures of the following formulae (1a), (2a) or (3a):

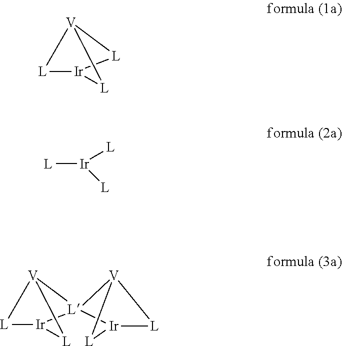

where the symbols used have the definitions given above.

There follows a description of the bidentate cyclometalated ligands or subligands L. When L′ is a bidentate cyclometalated ligand or subligand, the preference that follows is also applicable to L′. The ligands or subligands L coordinate to the iridium via one carbon atom and one nitrogen atom or via two carbon atoms. When L coordinates to the iridium via two carbon atoms, one of the two carbon atoms is a carbene carbon atom. In a preferred embodiment of the invention, at least two ligands or subligands L and L′ are identical. In complexes of the formula (2), preferably all ligands L and L′ are identical, and so the complex is a homoleptic complex.

More preferably, each ligand or subligand L and L′ has one carbon atom and one nitrogen atom as coordinating atoms.

It is further preferable when the metallacycle which is formed from the iridium and the ligand or subligand L or L′ is a five-membered ring. This is shown schematically hereinafter:

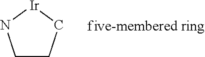

where N represents a coordinating nitrogen atom and C a coordinating carbon atom, and the carbon atoms shown represent atoms of the ligand or subligand L or L′.

In a preferred embodiment of the invention, the ligands or subligands L and, if appropriate, L′ are the same or different at each instance and are a structure of the following formulae (L-1) and (L-2):

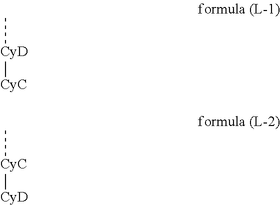

where the dotted bond represents the bond of the subligand to the bridge V in formula (1) or (3) and is absent for formula (2) and where the other symbols used are as follows:
CyC is the same or different at each instance and is a substituted or unsubstituted aryl or heteroaryl group which has 5 to 14 aromatic ring atoms and coordinates in each case to the metal via a carbon atom and which is bonded to CyD via a covalent bond;
CyD is the same or different at each instance and is a substituted or unsubstituted heteroaryl group which has 5 to 14 aromatic ring atoms and coordinates to the metal via a nitrogen atom or via a carbene carbon atom and which is bonded to CyC via a covalent bond;
   at the same time, two or more of the optional substituents together may form a ring system; the optional radicals are preferably selected from the R radicals defined below.

CyD coordinates via an uncharged nitrogen atom or via a carbene carbon atom, and CyC coordinates via an anionic carbon atom.

For the R radicals on CyC and CyD, it is preferably the case that:
R is the same or different at each instance and is H, D, F, Cl, Br, I, N(R¹)₂, OR¹, SR¹, CN, NO₂, COOR¹, C(═O)N(R¹)₂, Si(R¹)₃, B(OR¹)₂, C(═O)R¹, P(═O)(R¹)₂, S(═O)R¹, S(═O)₂R¹, OSO₂R¹, a straight-chain alkyl group having 1 to 20 carbon atoms or an alkenyl or alkynyl group having 2 to 20 carbon atoms or a branched or cyclic alkyl group having 3 to 20 carbon atoms, where the alkyl, alkenyl or alkynyl group may in each case be substituted by one or more R¹ radicals and where one or more nonadjacent CH₂ groups may be replaced by Si(R¹)₂, C═O, NR¹, O, S or CONR¹, or an aromatic or heteroaromatic ring system which has 5 to 40 aromatic ring atoms and may be substituted in each case by one or more nonaromatic R¹ radicals; at the same time, two R radicals together may also form a ring system;
R¹ is the same or different at each instance and is H, D, F, Cl, Br, I, N(R²)₂, OR², SR², CN, NO₂, Si(R²)₃, B(OR²)₂, C(═O)R², P(═O)(R²)₂, S(═O)R², S(═O)₂R², OSO₂R², a straight-chain alkyl group having 1 to 20 carbon atoms or an alkenyl or alkynyl group having 2 to 20 carbon atoms or a branched or cyclic alkyl group having 3 to 20 carbon atoms, where the alkyl, alkenyl or alkynyl group may in each case be substituted by one or more R² radicals and where one or more nonadjacent CH₂ groups may be replaced by Si(R²)₂, C═O, NR², O, S or CONR², or an aromatic or heteroaromatic ring system which has 5 to 40 aromatic ring atoms and may be substituted in each case by one or more R² radicals; at the same time, two or more R¹ radicals together may form a ring system;
R² is the same or different at each instance and is H, D, F or an aliphatic organic radical, especially a hydrocarbyl radical, having 1 to 20 carbon atoms, in which one or more hydrogen atoms may also be replaced by F.

When two R or R¹ radicals together form a ring system, it may be mono- or polycyclic, aliphatic, heteroaliphatic, aromatic or heteroaromatic. In this case, these radicals which together form a ring system may be adjacent, meaning that these radicals are bonded to the same carbon atom or to carbon atoms directly bonded to one another, or they may be further removed from one another. In addition, it is also possible that the substituents on CyC and CyD together form a ring, as a result of which CyC and CyD may also together form a single fused aryl or heteroaryl group as bidentate ligand.

The wording that two or more radicals together may form a ring, in the context of the present description, should be understood to mean, inter alia, that the two radicals are joined to one another by a chemical bond with formal elimination of two hydrogen atoms. This is illustrated by the following scheme:

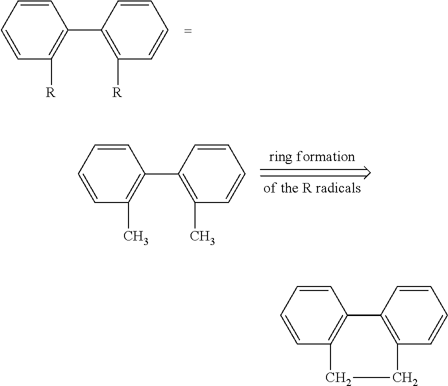

In addition, the abovementioned wording shall also be understood to mean that, if one of the two radicals is hydrogen, the second radical binds to the position to which the hydrogen atom was bonded, forming a ring. This shall be illustrated by the following scheme:

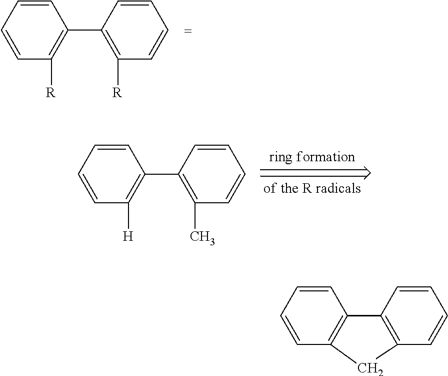

In addition, the abovementioned wording shall also be understood to mean that, if the two radicals are alkenyl groups, the radicals together form a ring, forming a fused-on aryl group. Analogously, the formation of a fused-on benzofuran group is possible in the case of an aryloxy substituent, and the formation of a fused-on indole group in the case of an arylamino substituent. This shall be illustrated by the following schemes:

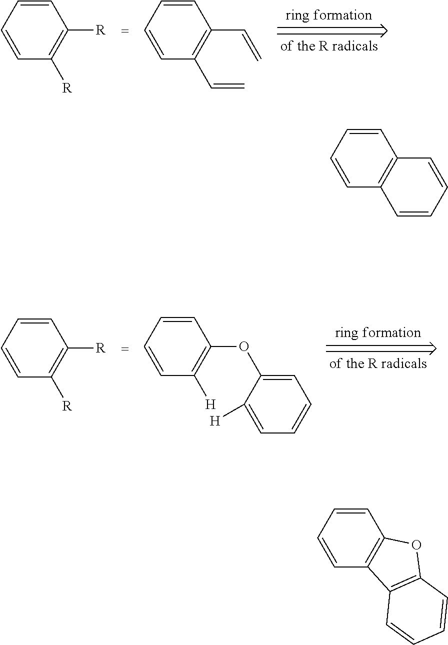

In the context of the present invention, the term “alkyl group” is used as an umbrella term both for linear or branched alkyl groups and for cyclic alkyl groups. Analogously, the terms “alkenyl group” and “alkynyl group” are used as umbrella terms both for linear or branched alkenyl or alkynyl groups and for cyclic alkynyl groups.

A cyclic alkyl, alkoxy or thioalkoxy group in the context of this invention is understood to mean a monocyclic, bicyclic or polycyclic group.

In the context of the present invention, a C₁- to C₂₀-alkyl group in which individual hydrogen atoms or CH₂ groups may also be substituted by the abovementioned groups is understood to mean, for example, the methyl, ethyl, n-propyl, i-propyl, cyclopropyl, n-butyl, i-butyl, s-butyl, t-butyl, cyclobutyl, 2-methylbutyl, n-pentyl, s-pentyl, t-pentyl, 2-pentyl, neopentyl, cyclopentyl, n-hexyl, s-hexyl, t-hexyl, 2-hexyl, 3-hexyl, neohexyl, cyclohexyl, 1-methylcyclopentyl, 2-methylpentyl, n-heptyl, 2-heptyl, 3-heptyl, 4-heptyl, cycloheptyl, 1-methylcyclohexyl, n-octyl, 2-ethylhexyl, cyclooctyl, 1-bicyclo[2.2.2]octyl, 2-bicyclo[2.2.2]octyl, 2-(2,6-dimethyl)octyl, 3-(3,7-dimethyl)octyl, adamantyl, trifluoromethyl, pentafluoroethyl, 2,2,2-trifluoroethyl, 1,1-dimethyl-n-hex-1-yl, 1,1-dimethyl-n-hept-1-yl, 1,1-dimethyl-n-oct-1-yl, 1,1-dimethyl-n-dec-1-yl, 1,1-dimethyl-n-dodec-1-yl, 1,1-dimethyl-n-tetradec-1-yl, 1,1-dimethyl-n-hexadec-1-yl, 1,1-dimethyl-n-octadec-1-yl, 1,1-diethyl-n-hex-1-yl, 1,1-diethyl-n-hept-1-yl, 1,1-diethyl-n-oct-1-yl, 1,1-diethyl-n-dec-1-yl, 1,1-diethyl-n-dodec-1-yl, 1,1-diethyl-n-tetradec-1-yl, 1,1-diethyl-n-hexadec-1-yl, 1,1-diethyl-n-octadec-1-yl, 1-(n-propyl)cyclohex-1-yl, 1-(n-butyl)cyclohex-1-yl, 1-(n-hexyl)cyclohex-1-yl, 1-(n-octyl)cyclohex-1-yl and 1-(n-decyl)cyclohex-1-yl radicals. An alkenyl group is understood to mean, for example, ethenyl, propenyl, butenyl, pentenyl, cyclopentenyl, hexenyl, cyclohexenyl, heptenyl, cycloheptenyl, octenyl, cyclooctenyl or cyclooctadienyl. An alkynyl group is understood to mean, for example, ethynyl, propynyl, butynyl, pentynyl, hexynyl, heptynyl or octynyl. An OR¹ group is understood to mean, for example, methoxy, trifluoromethoxy, ethoxy, n-propoxy, i-propoxy, n-butoxy, i-butoxy, s-butoxy, t-butoxy or 2-methylbutoxy.

An aryl group in the context of this invention contains 6 to 30 carbon atoms; a heteroaryl group in the context of this invention contains 2 to 30 carbon atoms and at least one heteroatom, with the proviso that the sum total of carbon atoms and heteroatoms is at least 5. The heteroatoms are preferably selected from N, O and/or S. Here, an aryl group or heteroaryl group is understood to mean either a simple aromatic ring, i.e. benzene, or a simple heteroaromatic ring, for example pyridine, pyrimidine, thiophene, etc., or a condensed (fused) aryl or heteroaryl group, for example naphthalene, anthracene, phenanthrene, quinoline, isoquinoline, etc. Aromatic systems joined to one another by a single bond, for example biphenyl, by contrast, are not referred to as an aryl or heteroaryl group but as an aromatic ring system.

An aromatic ring system in the context of this invention contains 6 to 40 carbon atoms, preferably 6 to 30 carbon atoms, in the ring system. A heteroaromatic ring system in the context of this invention contains 2 to 40 carbon atoms, preferably 2 to 30 carbon atoms, and at least one heteroatom in the ring system, with the proviso that the sum total of carbon atoms and heteroatoms is at least 5. The heteroatoms are preferably selected from N, O and/or S. An aromatic or heteroaromatic ring system in the context of this invention shall be understood to mean a system which does not necessarily contain only aryl or heteroaryl groups, but in which it is also possible for two or more aryl or heteroaryl groups to be joined by a non-aromatic unit, for example a carbon, nitrogen or oxygen atom. These shall likewise be understood to mean systems in which two or more aryl or heteroaryl groups are joined directly to one another, for example biphenyl, terphenyl, bipyridine or phenylpyridine. For example, systems such as fluorene, 9,9′-spirobifluorene, 9,9-diarylfluorene, triarylamine, diaryl ethers, stilbene, etc. shall also be regarded as aromatic ring systems in the context of this invention, and likewise systems in which two or more aryl groups are joined, for example, by a short alkyl group. Preferred aromatic or heteroaromatic ring systems are simple aryl or heteroaryl groups and groups in which two or more aryl or heteroaryl groups are joined directly to one another, for example biphenyl or bipyridine, and also fluorene or spirobifluorene.

An aromatic or heteroaromatic ring system which has 5-40 aromatic ring atoms and may also be substituted in each case by the abovementioned R² radicals or a hydrocarbyl radical and which may be joined to the aromatic or heteroaromatic system via any desired positions is understood to mean especially groups derived from benzene, naphthalene, anthracene, benzanthracene, phenanthrene, pyrene, chrysene, perylene, fluoranthene, naphthacene, pentacene, benzopyrene, biphenyl, biphenylene, terphenyl, triphenylene, fluorene, spirobifluorene, dihydrophenanthrene, dihydropyrene, tetrahydropyrene, cis- or trans-indenofluorene, cis- or trans-indenocarbazole, cis- or trans-indolocarbazole, truxene, isotruxene, spirotruxene, spiroisotruxene, furan, benzofuran, isobenzofuran, dibenzofuran, thiophene, benzothiophene, isobenzothiophene, dibenzothiophene, pyrrole, indole, isoindole, carbazole, pyridine, quinoline, isoquinoline, acridine, phenanthridine, benzo-5,6-quinoline, benzo-6,7-quinoline, benzo-7,8-quinoline, phenothiazine, phenoxazine, pyrazole, indazole, imidazole, benzimidazole, naphthimidazole, phenanthrimidazole, pyridimidazole, pyrazinimidazole, quinoxalinimidazole, oxazole, benzoxazole, naphthoxazole, anthroxazole, phenanthroxazole, isoxazole, 1,2-thiazole, 1,3-thiazole, benzothiazole, pyridazine, hexaazatriphenylene, benzopyridazine, pyrimidine, benzopyrimidine, quinoxaline, 1,5-diazaanthracene, 2,7-diazapyrene, 2,3-diazapyrene, 1,6-diazapyrene, 1,8-diazapyrene, 4,5-diazapyrene, 4,5,9,10-tetraazaperylene, pyrazine, phenazine, phenoxazine, phenothiazine, fluorubine, naphthyridine, azacarbazole, benzocarboline, phenanthroline, 1,2,3-triazole, 1,2,4-triazole, benzotriazole, 1,2,3-oxadiazole, 1,2,4-oxadiazole, 1,2,5-oxadiazole, 1,3,4-oxadiazole, 1,2,3-thiadiazole, 1,2,4-thiadiazole, 1,2,5-thiadiazole, 1,3,4-thiadiazole, 1,3,5-triazine, 1,2,4-triazine, 1,2,3-triazine, tetrazole, 1,2,4,5-tetrazine, 1,2,3,4-tetrazine, 1,2,3,5-tetrazine, purine, pteridine, indolizine and benzothiadiazole, or groups derived from a combination of these systems.

Preferably, all ligands or subligands L and, if appropriate, L′ have a structure of the formula (L-1), or all ligands or subligands L and, if appropriate, L′ have a structure of the formula (L-2).

In a preferred embodiment of the present invention, CyC is an aryl or heteroaryl group having 6 to 13 aromatic ring atoms, more preferably having 6 to 10 aromatic ring atoms, most preferably having 6 aromatic ring atoms, which coordinates to the metal via a carbon atom, which may be substituted by one or more R radicals and which is bonded to CyD via a covalent bond.

Preferred embodiments of the CyC group are the structures of the following formulae (CyC-1) to (CyC-20) where the CyC group binds in each case at the position signified by #to CyD and coordinates at the position signified by * to the iridium,

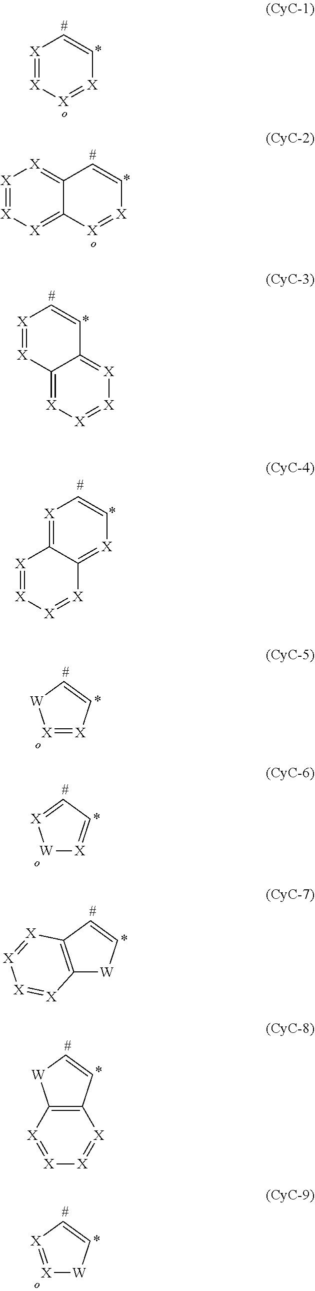

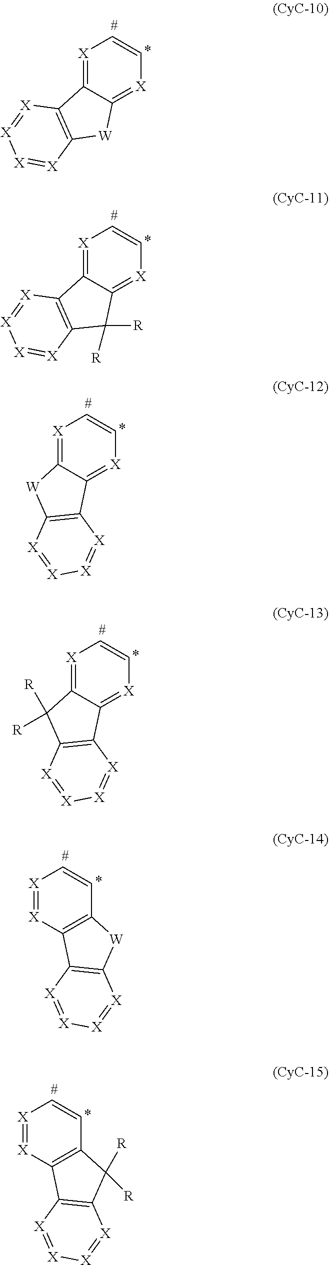

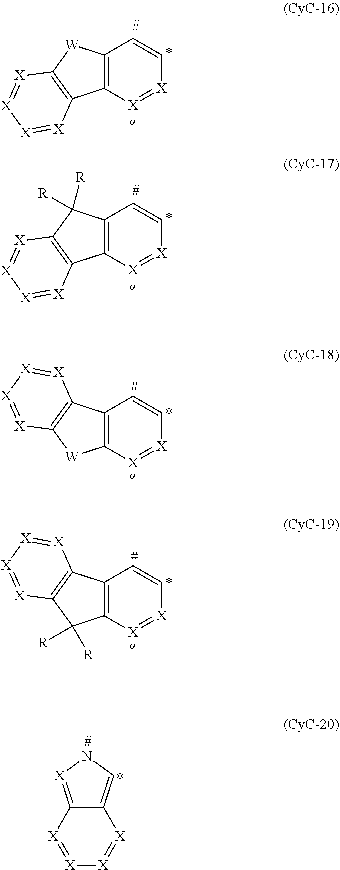

where R is as defined above and, in addition:
X is the same or different at each instance and is CR or N, with the proviso that at most two symbols X per ring are N;
W is the same or different at each instance and is NR, O, S or BR;
   with the proviso that, when the bridge V is bonded to CyC in formula (1) or (3), one symbol X is C and the bridge V is bonded to this carbon atom. When the CyC group is bonded to the bridge V, the bond is preferably via the position marked “o” in the formulae depicted above, and so the symbol X marked “o” in that case is preferably C. The above-depicted structures which do not contain any symbol X marked “o” are preferably not bonded directly to the bridge V, since such a bond to the bridge is not advantageous for steric reasons.

Preferably not more than one symbol X in CyC is N, and more preferably all symbols X are CR, with the proviso that, when the bridge V in formula (1) is bonded to CyC, one symbol X is C and the bridge V is bonded to this carbon atom.

Preferred CyC groups are the groups of the following formulae (CyC-1a) to (CyC-20a):

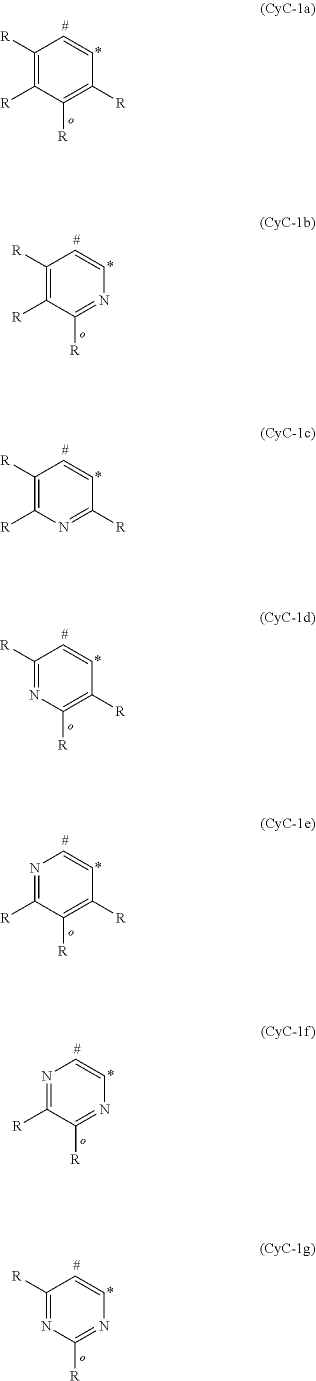

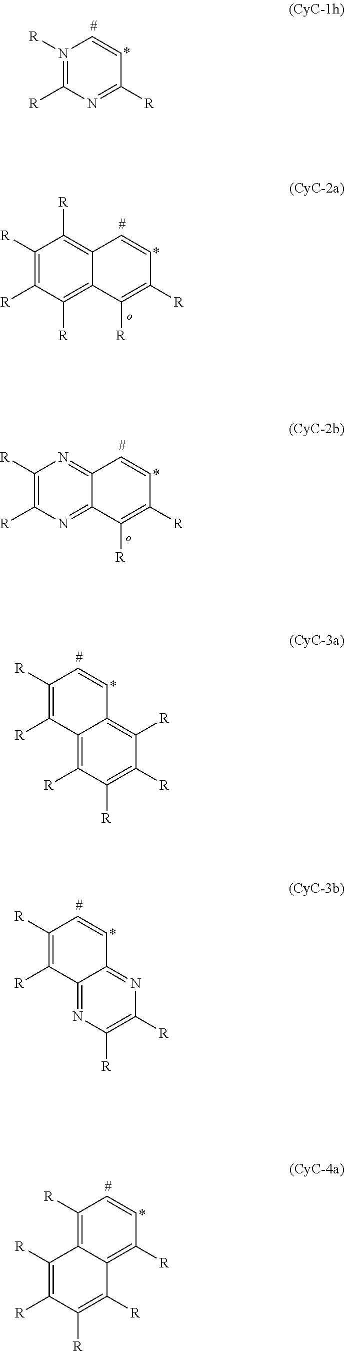

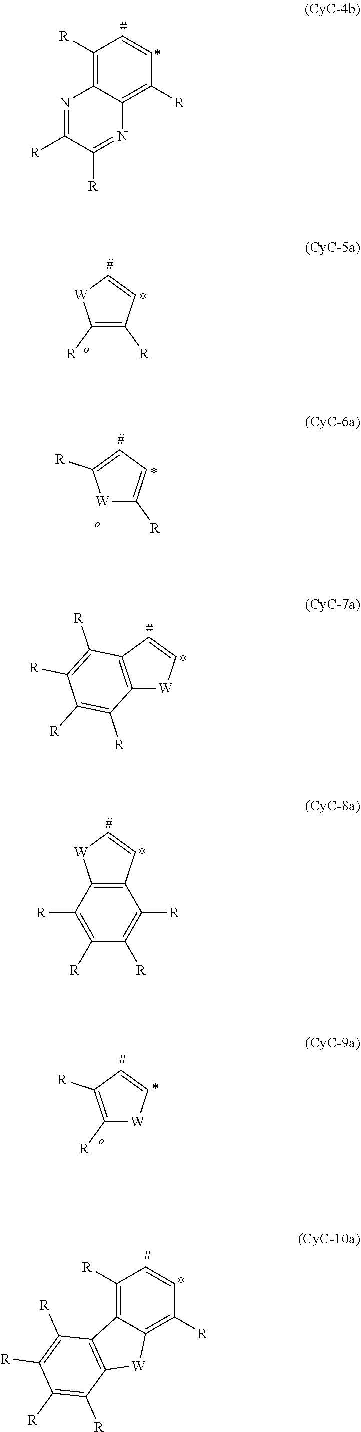

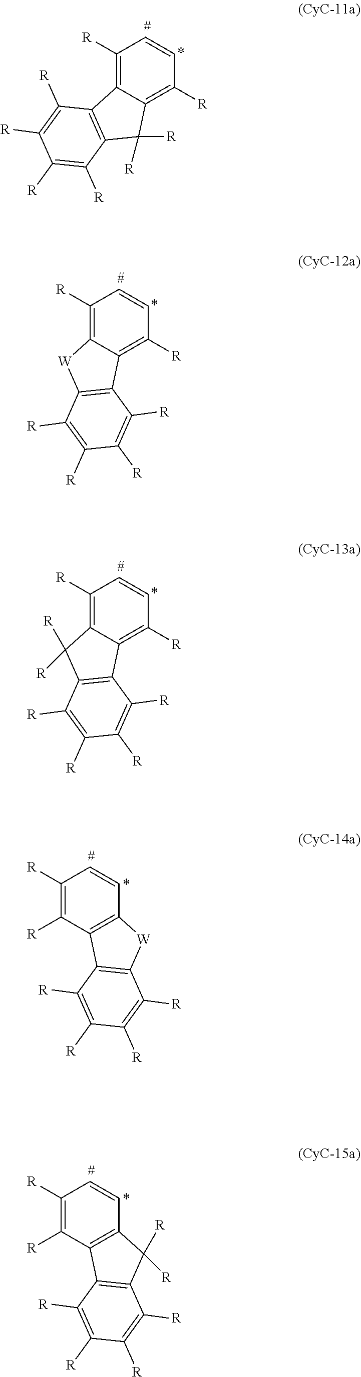

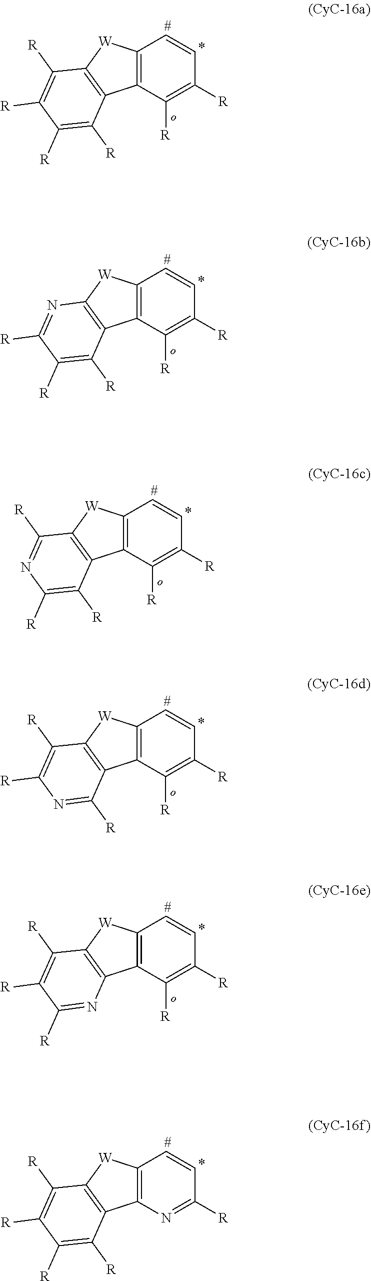

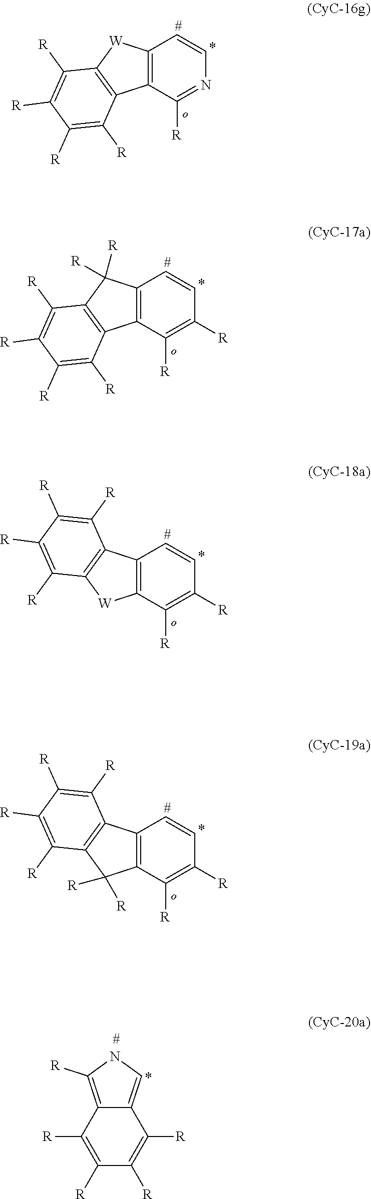

where the symbols used have the definitions given above and, when the bridge V is bonded to CyC in formula (1) or (3), one R radical is absent and the bridge V is bonded to the corresponding carbon atom. When the CyC group is bonded to the bridge V, the bond is preferably via the position marked “o” in the formulae depicted above, and so the R radical in this position in that case is preferably absent. The above-depicted structures which do not contain any carbon atom marked “o” are preferably not bonded directly to the bridge V.

Preferred groups among the (CyC-1) to (CyC-19) groups are the (CyC-1), (CyC-3), (CyC-8), (CyC-10), (CyC-12), (CyC-13) and (CyC-16) groups, and particular preference is given to the (CyC-1a), (CyC-3a), (CyC-8a), (CyC-10a), (CyC-12a), (CyC-13a) and (CyC-16a) groups.

In a further preferred embodiment of the invention, CyD is a heteroaryl group having 5 to 13 aromatic ring atoms, more preferably having 6 to 10 aromatic ring atoms, which coordinates to the metal via an uncharged nitrogen atom or via a carbene carbon atom and which may be substituted by one or more R radicals and which is bonded via a covalent bond to CyC.

Preferred embodiments of the CyD group are the structures of the following formulae (CyD-1) to (CyD-12) where the CyD group binds in each case at the position signified by #to CyC and coordinates at the position signified by * to the iridium,

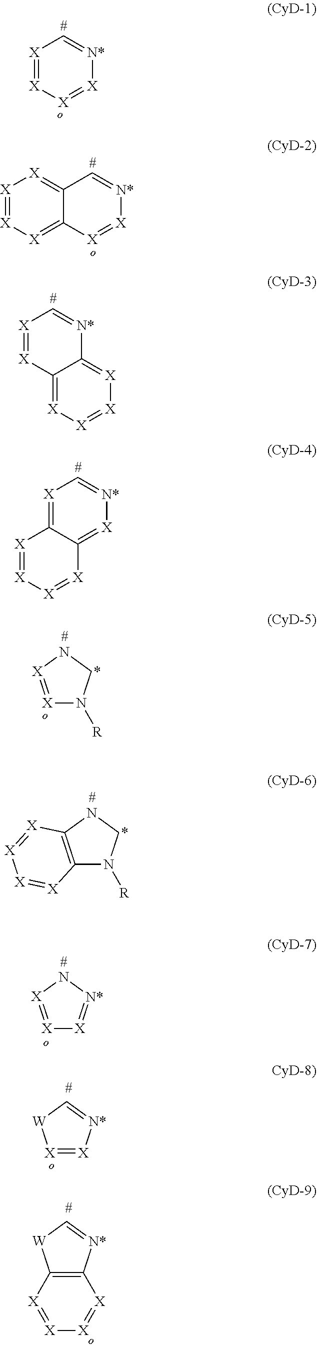

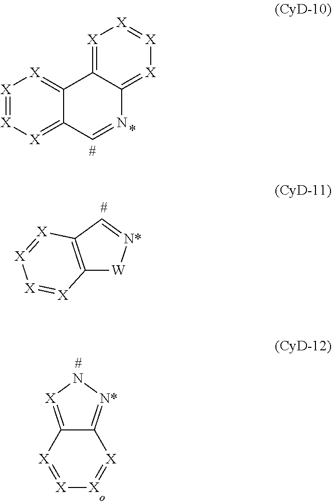

where X, W and R have the definitions given above, with the proviso that, when the bridge V in formula (1) or (3) is bonded to CyD, one symbol X is C and the bridge V is bonded to this carbon atom. When the CyD group is bonded to the bridge V, the bond is preferably via the position marked “o” in the formulae depicted above, and so the symbol X marked “o” in that case is preferably C. The above-depicted structures which do not contain any symbol X marked “o” are preferably not bonded directly to the bridge V, since such a bond to the bridge is not advantageous for steric reasons.

In this case, the (CyD-1) to (CyD-4) and (CyD-7) to (CyD-12) groups coordinate to the iridium via an uncharged nitrogen atom, and (CyD-5) and (CyD-6) groups via a carbene carbon atom.

Preferably not more than one symbol X in CyD is N, and more preferably all symbols X are CR, with the proviso that, when the bridge V in formula (1) or (3) is bonded to CyD, one symbol X is C and the bridge V is bonded to this carbon atom.

Particularly preferred CyD groups are the groups of the following formulae (CyD-1a) to (CyD-12b):

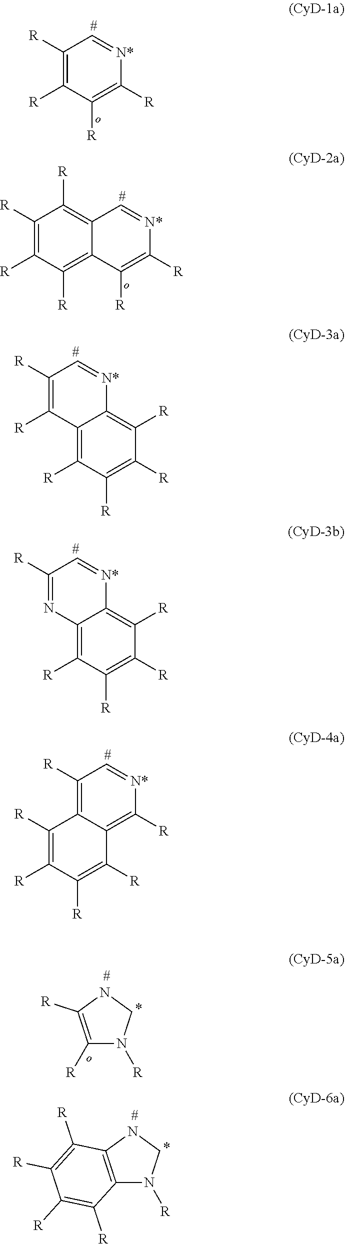

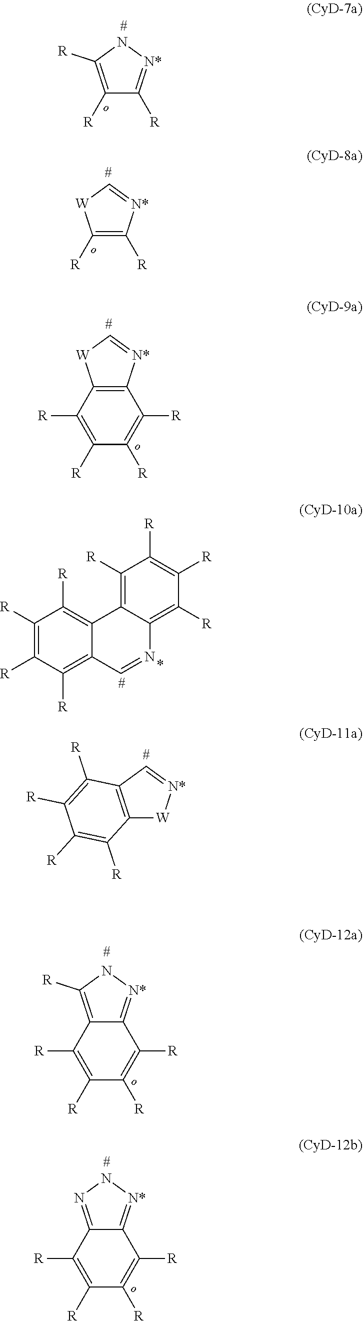

where the symbols used have the definitions given above and, when the bridge V is bonded to CyD in formula (1) or (3), one R radical is absent and the bridge V is bonded to the corresponding carbon atom. When the CyD group is bonded to the bridge V, the bond is preferably via the position marked “o” in the formulae depicted above, and so the R radical in this position in that case is preferably absent. The above-depicted structures which do not contain any carbon atom marked “o” are preferably not bonded directly to the bridge V.

Preferred groups among the (CyD-1) to (CyD-12) groups are the (CyD-1), (CyD-2), (CyD-3), (CyD-4), (CyD-5) and (CyD-6) groups, especially (CyD-1), (CyD-2) and (CyD-3), and particular preference is given to the (CyD-1a), (CyD-2a), (CyD-3a), (CyD-4a), (CyD-5a) and (CyD-6a) groups, especially (CyD-1a), (CyD-2a) and (CyD-3a).

In a preferred embodiment of the present invention, CyC is an aryl or heteroaryl group having 6 to 13 aromatic ring atoms, and at the same time CyD is a heteroaryl group having 5 to 13 aromatic ring atoms. More preferably, CyC is an aryl or heteroaryl group having 6 to 10 aromatic ring atoms, and at the same time CyD is a heteroaryl group having 5 to 10 aromatic ring atoms. Most preferably, CyC is an aryl or heteroaryl group having 6 aromatic ring atoms, and CyD is a heteroaryl group having 6 to 10 aromatic ring atoms. At the same time, CyC and CyD may each be substituted by one or more R radicals.

The abovementioned preferred groups (CyC-1) to (CyC-20) and (CyD-1) to (CyD-12) may be combined with one another as desired. It is necessary here for compounds of the formula (1) or (3) that at least one of the CyC or CyD groups has a suitable linkage site to the bridge V, where suitable linkage sites in the abovementioned formulae are identified by “o”.

It is especially preferable when the CyC and CyD groups mentioned as preferred above, i.e. the groups of the formulae (CyC-1a) to (CyC-20a) and the groups of the formulae (CyD1-a) to (CyD-14b), are combined with one another.

It is very particularly preferable when one of the (CyC-1), (CyC-3), (CyC-8), (CyC-10), (CyC-12), (CyC-13) and (CyC-16) groups, especially the (CyC-1a), (CyC-3a), (CyC-8a), (CyC-10a), (CyC-12a), (CyC-13a) and (CyC-16a) groups, is combined with one of the (CyD-1), (CyD-2) and (CyD-3) groups, especially with one of the (CyD-1a), (CyD-2a) and (CyD-3a) groups.

Preferred subligands (L-1) are the structures of the formulae (L-1-1) and (L-1-2), and preferred subligands (L-2) are the structures of the formulae (L-2-1) to (L-2-4):

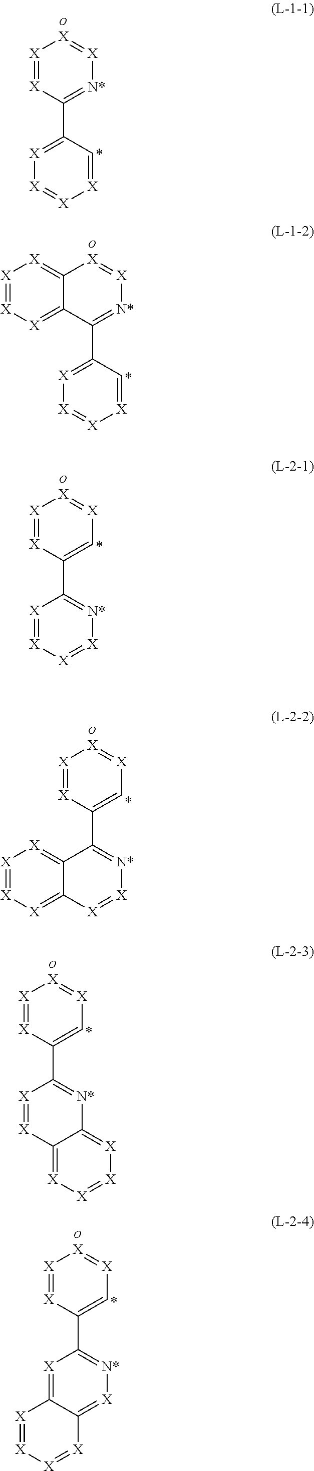

where the symbols used have the definitions given above and “o” in compounds of the formula (1) or (3) represents the position of the bond to the bridge V, in which case the corresponding X is C.

Particularly preferred subligands (L-1) are the structures of the formulae (L-1-1a) and (L-1-2b), and particularly preferred subligands (L-2) are the structures of the formulae (L-2-1a) to (L-2-4a)

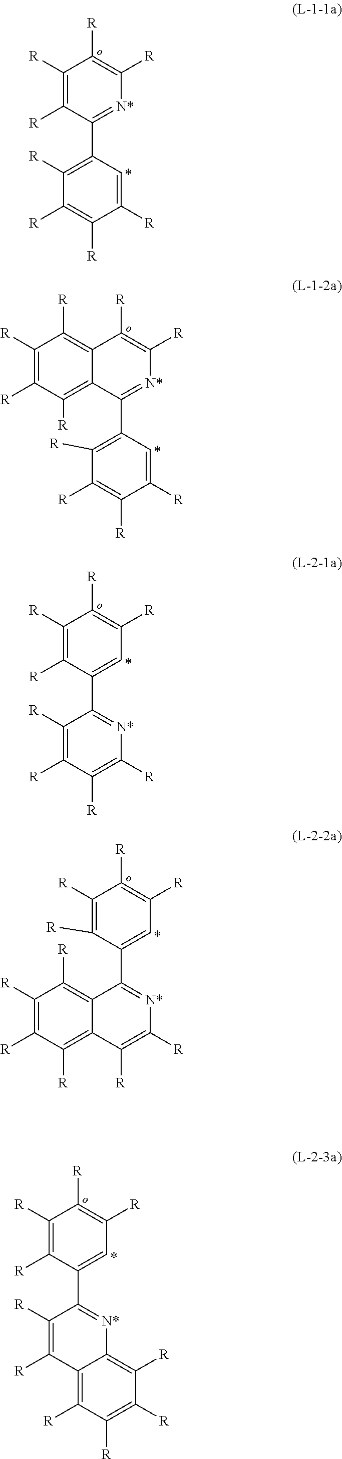

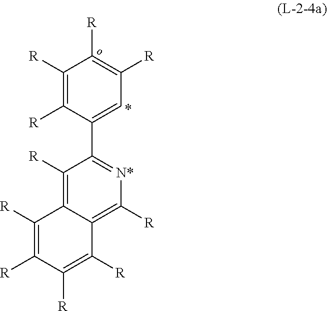

where the symbols used have the definitions given above and “o” in formula (1) or (3) represents the position of the bond to the bridge V, in which case the corresponding R radical is absent.

When two R radicals of which one is bonded to CyC and the other to CyD together form a ring system, this can result in bridged ligands or subligands L or L′, in which case some of these bridged subligands overall form a single larger heteroaryl group, for example benzo[h]quinoline, etc. The ring between the substituents on CyC and CyD is preferably formed by a group of one of the following formulae (6) to (15):

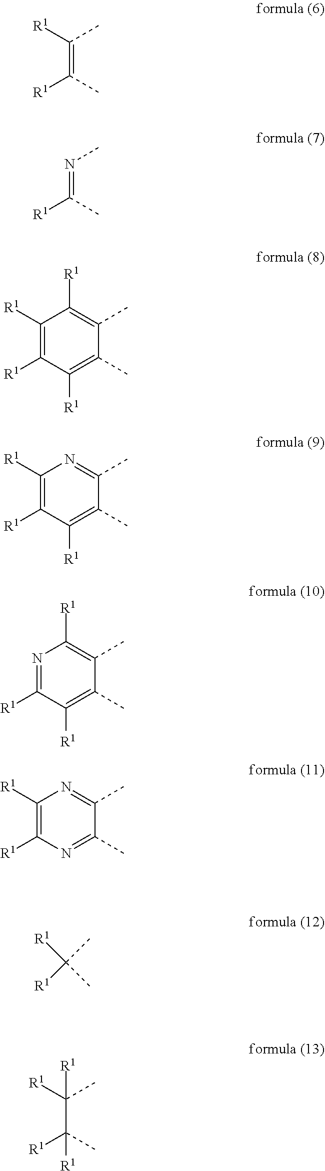

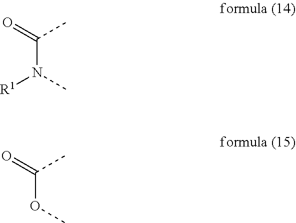

where R¹ has the definitions given above and the dotted bonds signify the bonds to CyC and CyD. It is possible here for the unsymmetric groups among those mentioned above to be incorporated in either of the two ways. For example, in the case of the group of the formula (15), the oxygen atom may bind to the CyC group and the carbonyl group to the CyD group, or the oxygen atom may bind to the CyD group and the carbonyl group to the CyC group.

At the same time, the group of the formula (12) is preferred particularly when this results in ring formation to give a six-membered ring, as shown below, for example, by the formulae (L-21) and (L-22).

Preferred ligands which arise through ring formation between two R radicals on the different cycles are the structures of the formulae (L-3) to (L-30) shown below:

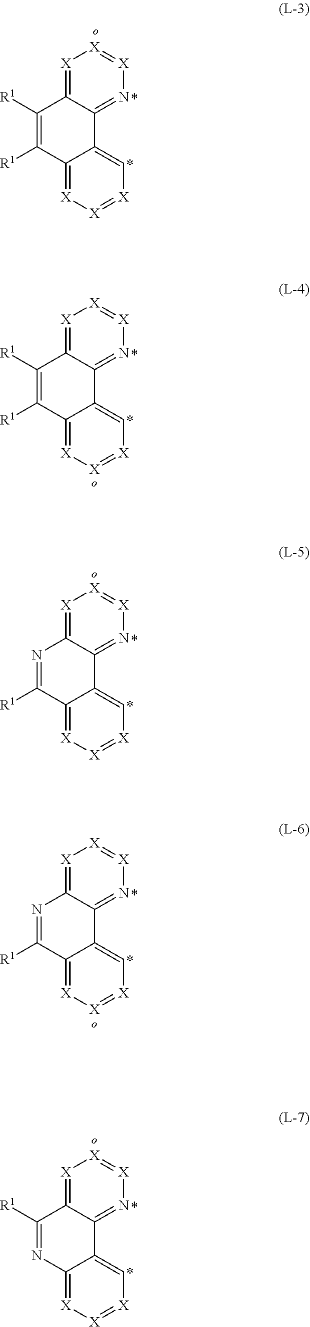

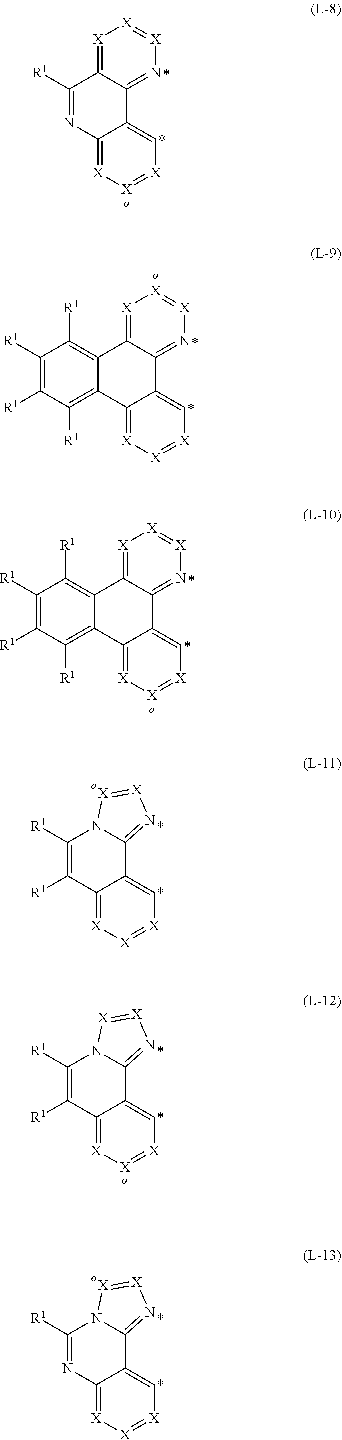

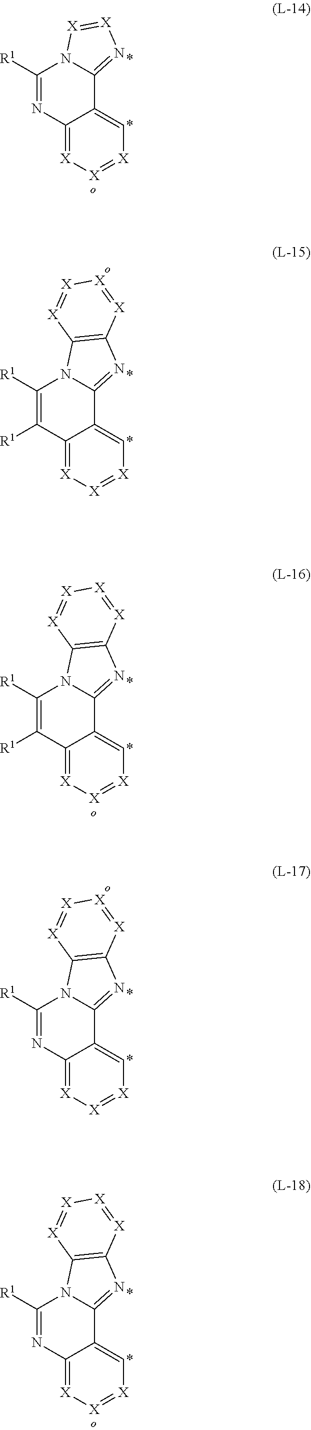

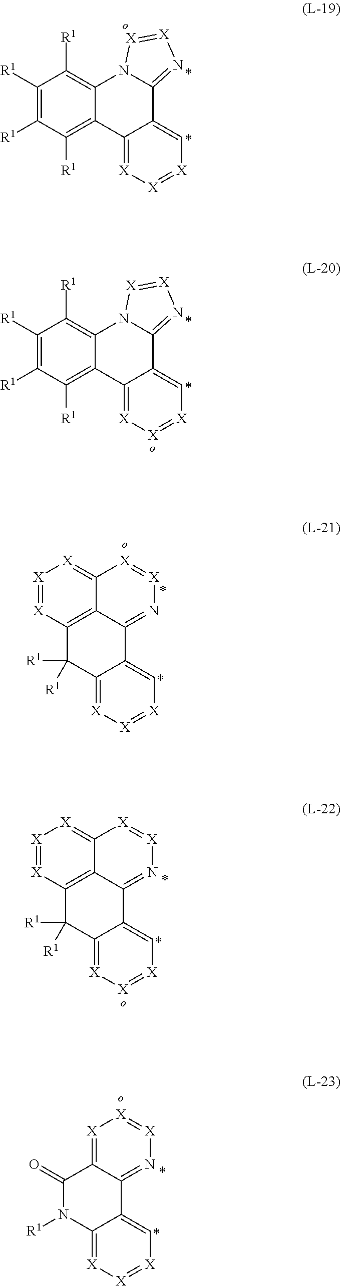

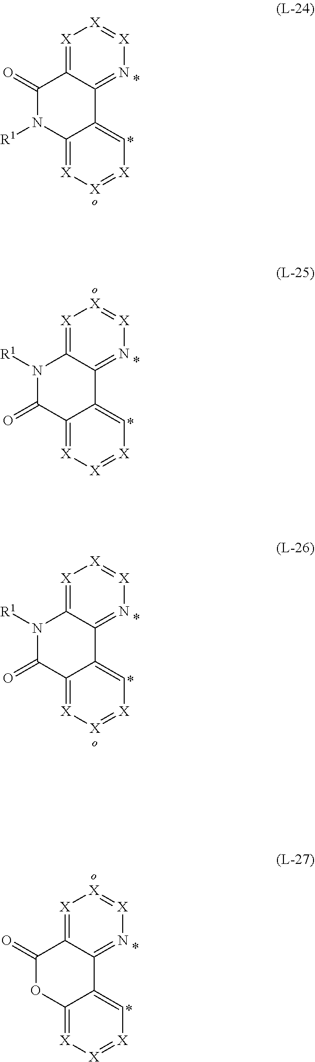

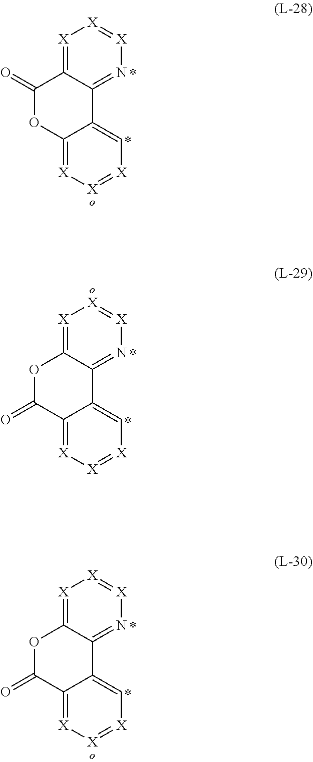

where the symbols used have the definitions given above and “o” in formula (1) or (3) indicates the position at which the subligand is joined to the V group and the corresponding symbol X is then C.

In a preferred embodiment of the ligands or subligands of the formulae (L-3) to (L-30), a total of one symbol X is N and the other symbols X are CR, or all symbols X are CR.

In a further embodiment of the invention, it is preferable if, in the groups (CyC-1) to (CyC-20) or (CyD-1) to (CyD-14) or in the ligands or subligands (L-1-1) to (L-30), one of the atoms X is N when an R group bonded as a substituent adjacent to this nitrogen atom is not hydrogen or deuterium. This applies analogously to the preferred structures (CyC-1a) to (CyC-20a) or (CyD-1a) to (CyD-14b) in which a substituent bonded adjacent to a non-coordinating nitrogen atom is preferably an R group which is not hydrogen or deuterium. In this case, this substituent R is preferably a group selected from CF₃, OCF₃, alkyl groups having 1 to 10 carbon atoms, especially branched or cyclic alkyl groups having 3 to 10 carbon atoms, OR¹, where R¹ is an alkyl group having 1 to 10 carbon atoms, especially a branched or cyclic alkyl group having 3 to 10 carbon atoms, dialkylamino groups having 2 to 10 carbon atoms or aryl or heteroaryl groups having 5 to 10 aromatic ring atoms. These groups are sterically demanding groups.

Further preferably, this R radical may also form a cycle with an adjacent R radical.

Further suitable bidentate ligands or subligands are the ligands or subligands of the following formulae (L-31) or (L-32):

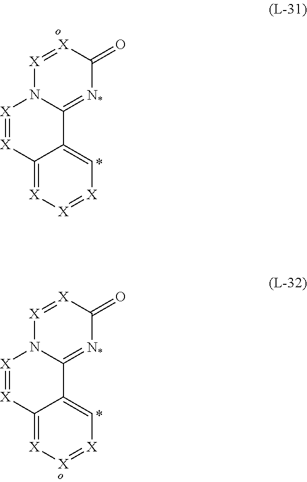

where R has the definitions given above, * represents the position of coordination to the iridium, “o” in formula (1) or (3) represents the position of linkage of the subligand to V and the further symbols used are as follows:
X is the same or different at each instance and is CR or N, with the proviso that not more than one X symbol per cycle is N.

When two R radicals bonded to adjacent carbon atoms in the ligands or subligands (L-31) and (L-32) form an aromatic cycle with one another, this cycle together with the two adjacent carbon atoms is preferably a structure of the following formula (16):

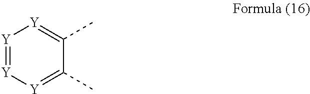

where the dotted bonds symbolize the linkage of this group within the ligand or subligand and Y is the same or different at each instance and is CR¹ or N and preferably not more than one symbol Y is N.

In a preferred embodiment of the ligand or subligand (L-31) or (L-32), not more than one such fused-on group is present. The ligands or subligands are thus preferably of the following formulae (L-33) to (L-38):

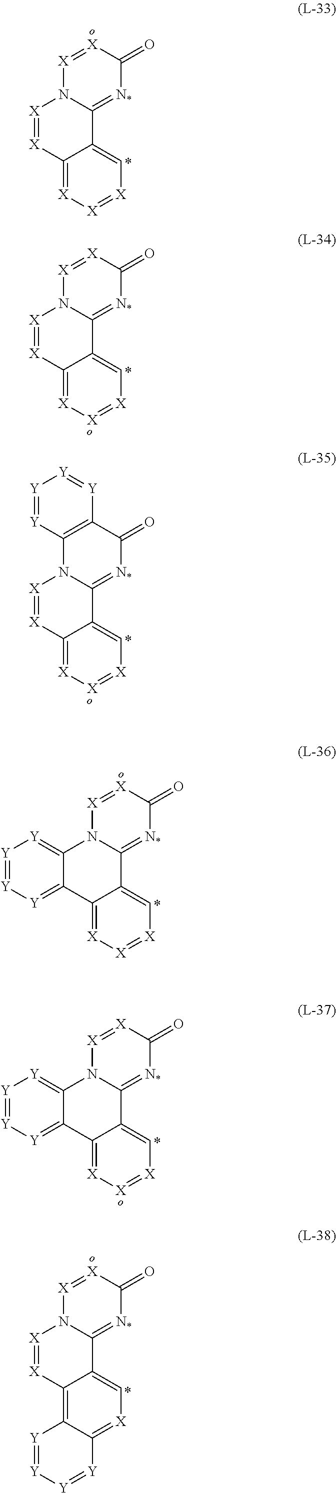

where X is the same or different at each instance and is CR or N, but the R radicals together do not form an aromatic or heteroaromatic ring system and the further symbols have the definitions given above.

In a preferred embodiment of the invention, in the ligand or subligand of the formulae (L-31) to (L-38), a total of 0, 1 or 2 of the symbols X and, if present, Y are N. More preferably, a total of 0 or 1 of the symbols X and, if present, Y are N.

Preferred embodiments of the formulae (L-33) to (L-38) are the structures of the following formulae (L-33a) to (L-38f):

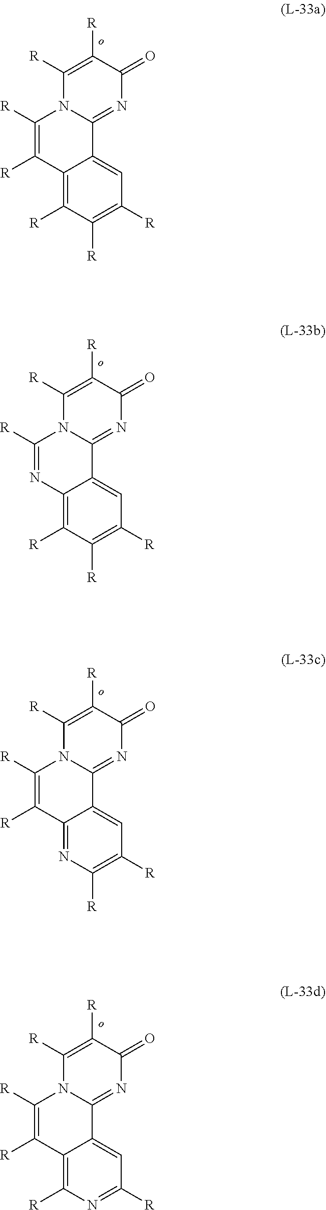

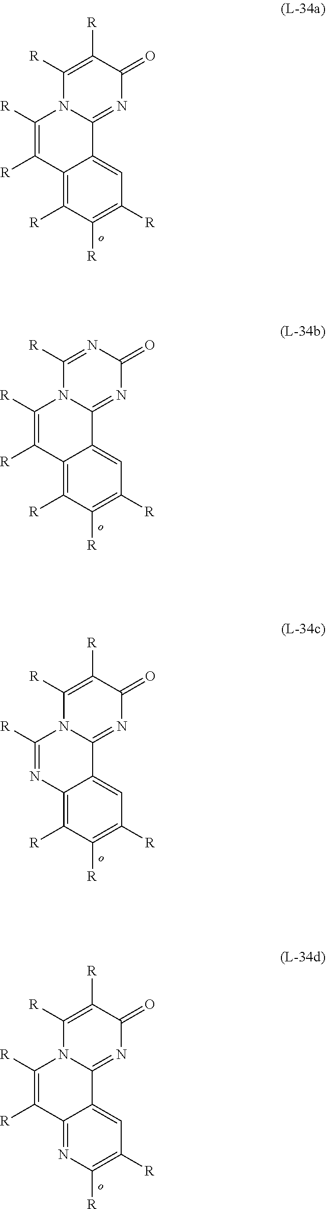

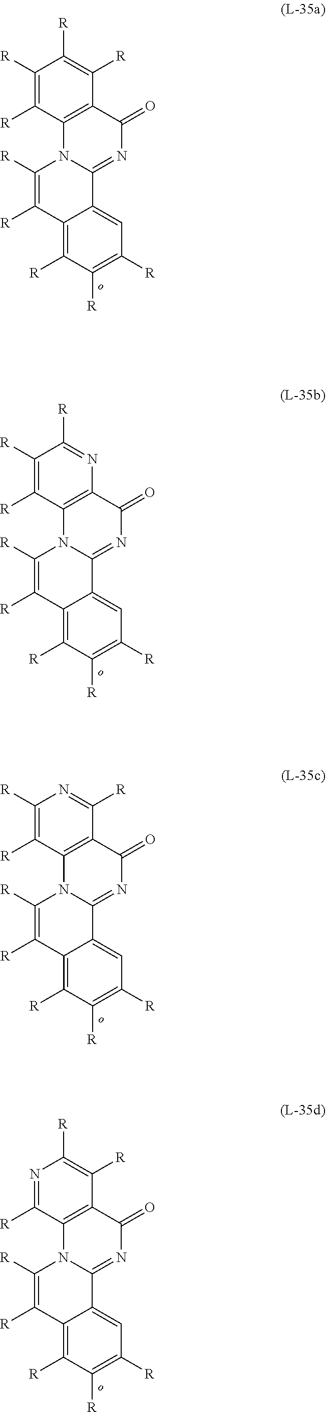

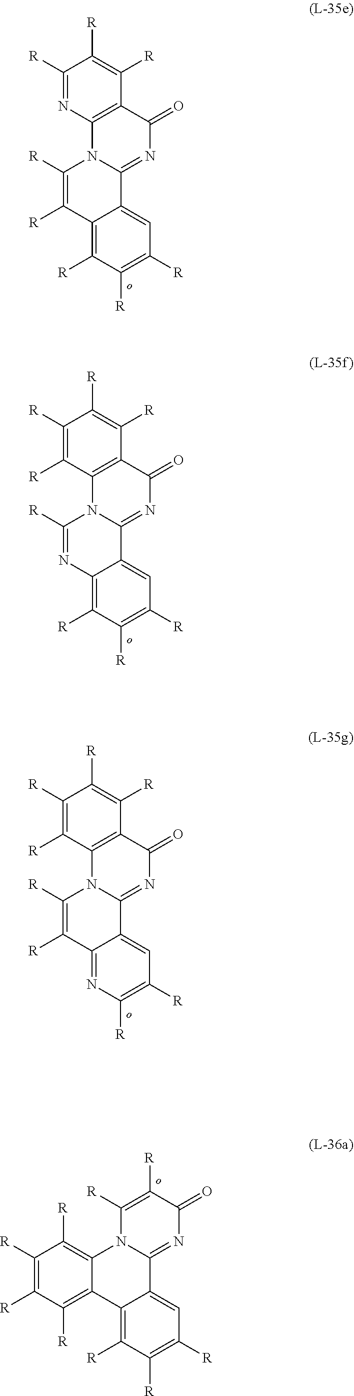

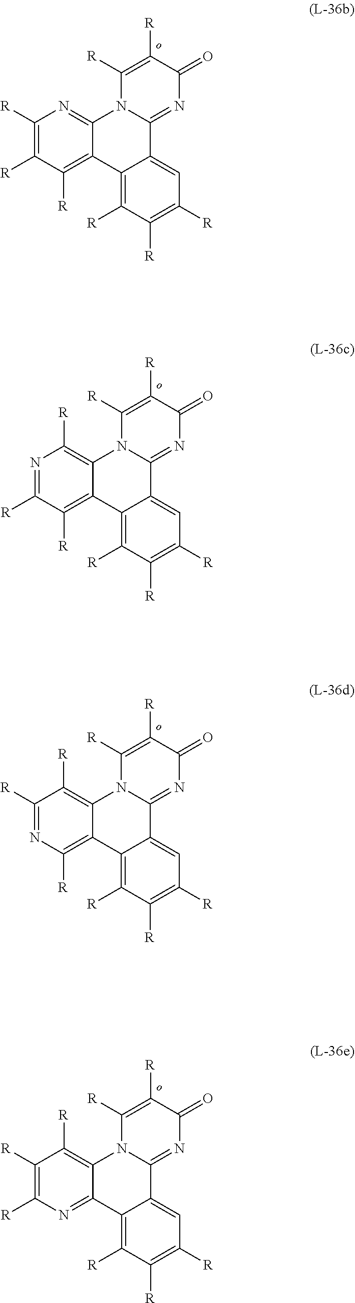

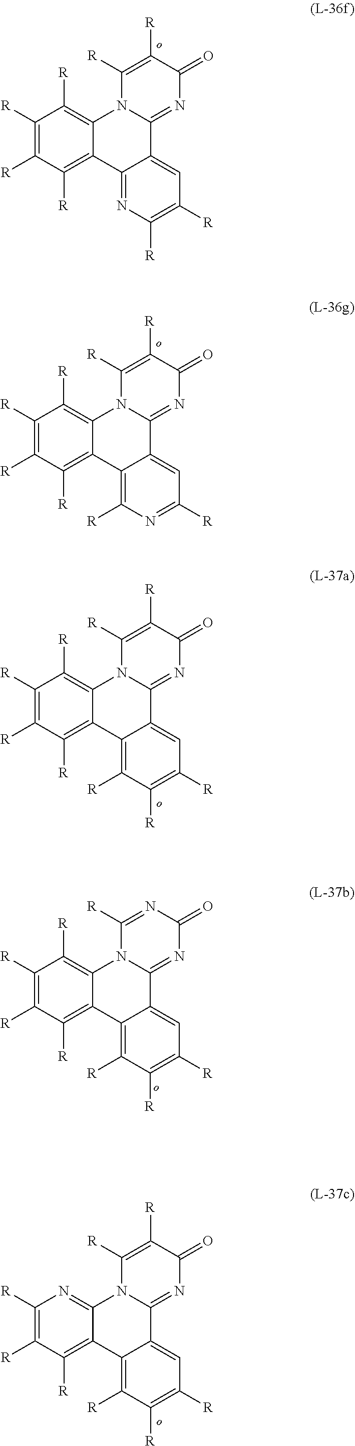

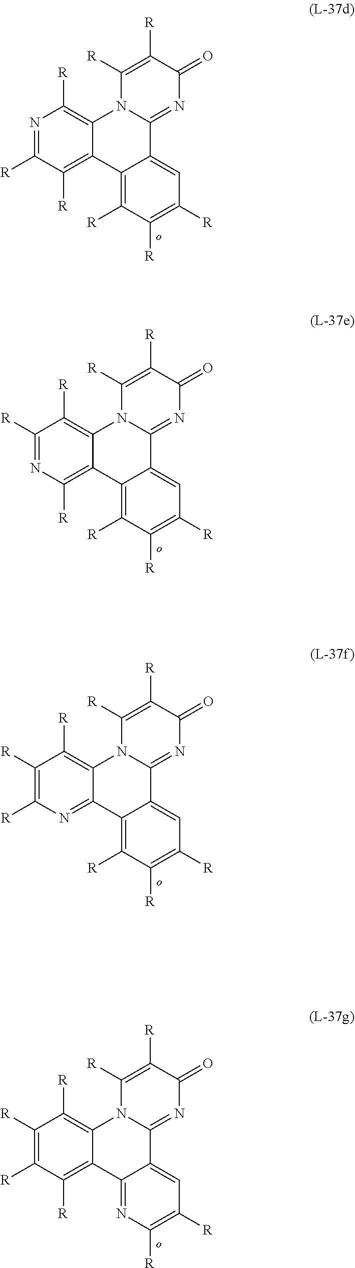

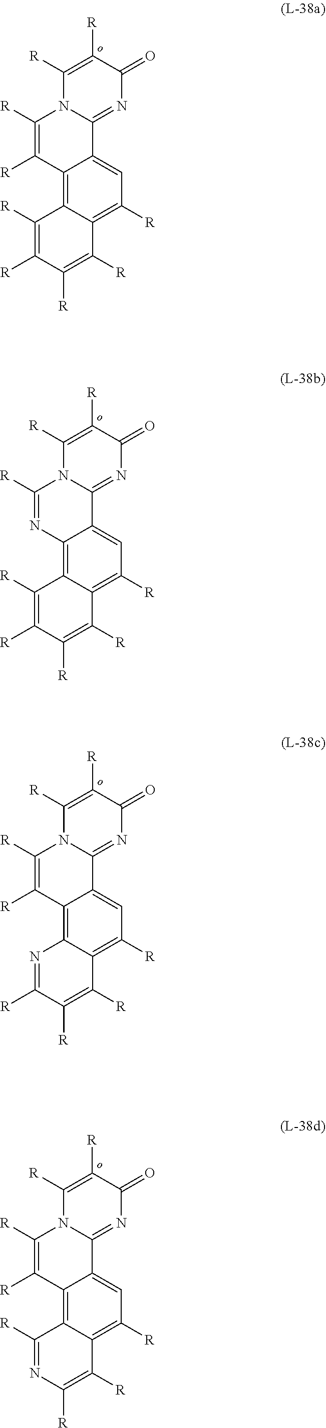

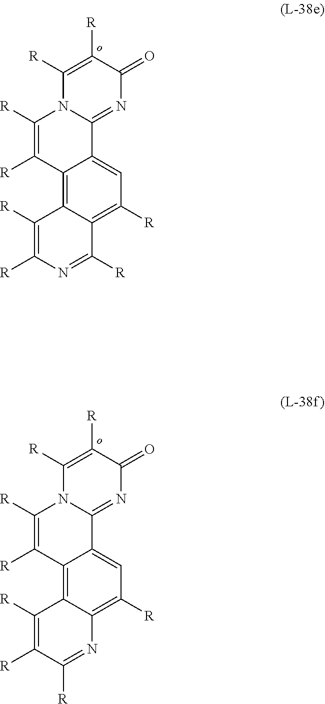

where the symbols used have the definitions given above and “o” in formula (1) or (3) indicates the position of the linkage to the bridge V, in which case the corresponding R group is absent.

In a preferred embodiment of the invention, the X group in the ortho position to the coordination to the metal is CR. The R radical bonded in the ortho position to the coordination to the metal is preferably selected from the group consisting of H, D, F and methyl.

In a further embodiment of the invention, it is preferable if one of the atoms X is N when a substituent bonded adjacent to this nitrogen atom is an R group which is not H or D. In this case, this substituent R is preferably a group selected from CF₃, OCF₃, alkyl groups having 1 to 10 carbon atoms, especially branched or cyclic alkyl groups having 3 to 10 carbon atoms, OR¹ where R¹ is an alkyl group having 1 to 10 carbon atoms, especially a branched or cyclic alkyl group having 3 to 10 carbon atoms, dialkylamino groups having 2 to 10 carbon atoms or aryl or heteroaryl groups having 5 to 10 aromatic ring atoms. These groups are sterically demanding groups. Further preferably, this R radical may also form a cycle with an adjacent R radical.

In a preferred embodiment of the invention, exactly one of the ligands or subligands L or L′ is a ligand or subligand of the following formula (L-39) that coordinates to the iridium via the two D groups:

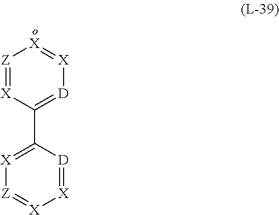

where “o” in formula (1) or (3) denotes the position of the bond to the bridge V, in which case the corresponding X is C; and also:
D is C or N, with the proviso that one D is C and the other D is N;
X is the same or different at each instance and is CR or N;
Z is CR′, CR or N, with the proviso that exactly one Z is CR′ and the other Z is CR or N;
   where a maximum of one symbol X or Z in total per cycle is N;
   R′ is a group of the following formula (17) or (18):

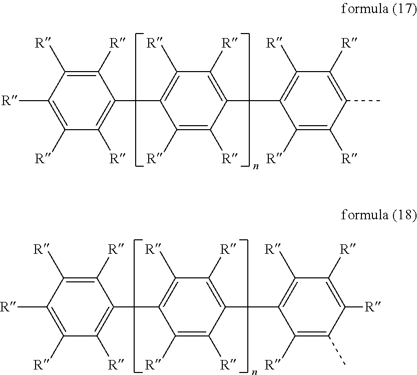

where the dotted bond indicates the attachment of the group;
R″ is the same or different at each instance and is H, D, F, CN, a straight-chain alkyl group having 1 to 10 carbon atoms in which one or more hydrogen atoms may also be replaced by D or F, or a branched or cyclic alkyl group having 3 to 10 carbon atoms in which one or more hydrogen atoms may also be replaced by D or F, or an alkenyl group having 2 to 10 carbon atoms in which one or more hydrogen atoms may also be replaced by D or F; at the same time, two adjacent R″ radicals or two R″ radicals on adjacent phenyl groups together may also form a ring system; or two R″ on adjacent phenyl groups together are a group selected from C(R¹)₂, NR¹, O and S, such that the two phenyl rings together with the bridging group are a carbazole, fluorene, dibenzofuran or dibenzothiophene, and the further R″ are as defined above;
n is 0, 1, 2, 3, 4 or 5.

In the case of ring formation by two substituents R″ on adjacent phenyl groups, the result may thus also be a fluorene or a phenanthrene or a triphenylene. It is likewise possible, as described above, for two R″ on adjacent phenyl groups together to be a group selected from NR¹, O and S, such that the two phenyl rings together with the bridging group are a carbazole, dibenzofuran or dibenzothiophene.

In a preferred embodiment of the invention, X is the same or different at each instance and is CR. Further preferably, one Z group is CR and the other Z group is CR′. More preferably, in the ligand or subligand of the formula (L-39), the X groups are the same or different at each instance and are CR, and at the same time one Z group is CR and the other Z group is CR′. The ligand or subligand L or L′ preferably has a structure of one of the following formulae (L-39a) or (L-39b), where the linkage to the bridge V for polypodal structures of the formula (L-39) is via the position identified by “o” and no R radical is bonded at this position,

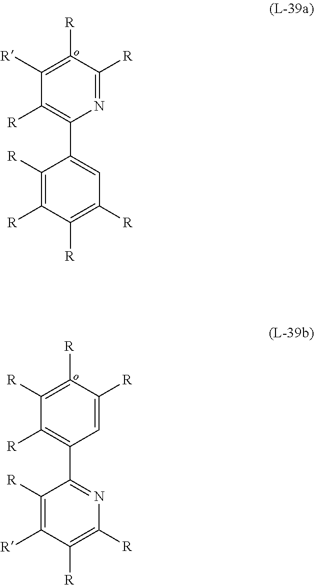

where the symbols used have the definitions given above and the R radical is absent when the subligand in formula (1) or (3) binds to the bridgehead V via the position identified by “o”.

More preferably, the subligand L of the formula (L-39) has a structure of one of the following formulae (L-39a′) or (L-39b′), where the linkage to the bridge V for polypodal structures of the formula (L-39) is via the position identified by “o” and no R radical is bonded at this position,

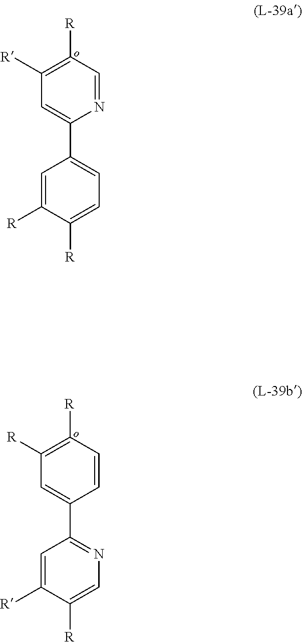

where the symbols used have the definitions given above.

The R radicals in the subligand L of the formula (L-39) or formulae (L-39a), (L-39b), (L-39a′) and (L-39d′) are preferably selected from the group consisting of H, D, CN, OR¹, a straight-chain alkyl group having 1 to 6 carbon atoms, preferably having 1, 2 or 3 carbon atoms, or a branched or cyclic alkyl group having 3, 4, 5 or 6 carbon atoms or an alkenyl group having 2 to 6 carbon atoms, preferably 2, 3 or 4 carbon atoms, each of which may be substituted by one or more R¹ radicals, or a phenyl group which may be substituted by one or more nonaromatic R¹ radicals. It is also possible here for two or more adjacent R radicals together to form a ring system.

In this case, the substituent R bonded to the coordinating atom in the ortho position is preferably selected from the group consisting of H, D, F and methyl, more preferably H, D and methyl and especially H and D.

In addition, it is preferable when all substituents R that are in the ortho position to R′ are H or D.

When the R radicals in the subligand L of the formula (L-39) together form a ring system, it is preferably an aliphatic, heteroaliphatic or heteroaromatic ring system. In addition, preference is given to ring formation between two R radicals on the two rings of the subligand L or L′, preferably forming a phenanthridine, or a phenanthridine which may contain still further nitrogen atoms. When R radicals together form a heteroaromatic ring system, this preferably forms a structure selected from the group consisting of quinoline, isoquinoline, dibenzofuran, dibenzothiophene and carbazole, each of which may be substituted by one or more R¹ radicals, and where individual carbon atoms in the dibenzofuran, dibenzothiophene and carbazole may also be replaced by N. Particular preference is given to quinoline, isoquinoline, dibenzofuran and azadibenzofuran. It is possible here for the fused-on structures to be bonded in any possible position. Preferred subligands L or L′ with fused-on benzo groups are the structures of the formulae (L-39c) to (L-39j) listed below, where the linkage to the bridge V for polypodal structures of the formula (L-39) is via the position identified by “o”:

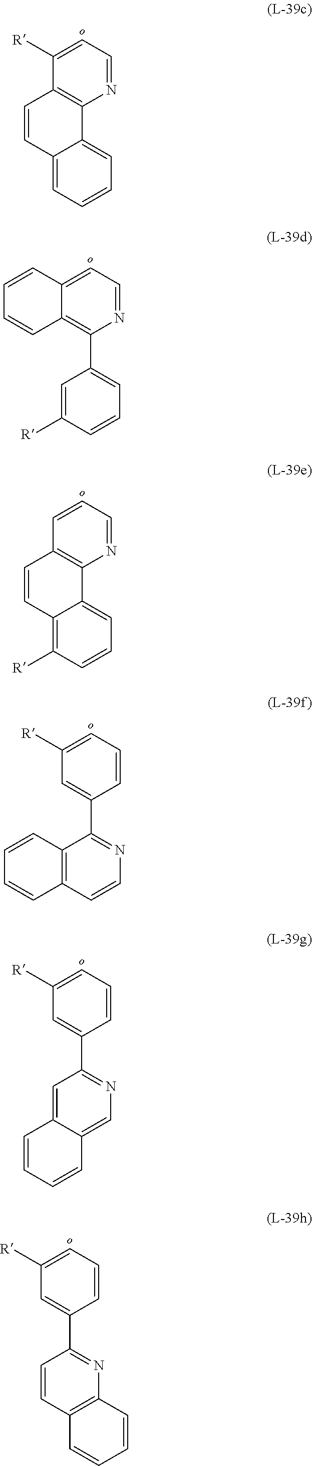

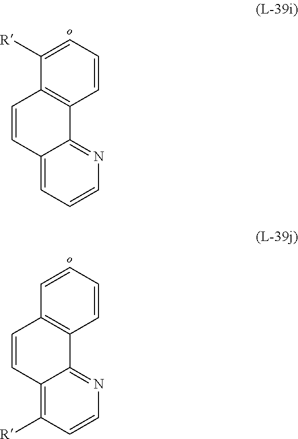

where the ligands may each also be substituted by one or more further R radicals and the fused-on structure may be substituted by one or more R¹ radicals. Preferably, there are no further R or R¹ radicals present.

Preferred subligands L or L′ of the formula (L-39) with fused-on benzofuran or azabenzofuran groups are the structures of the formulae (L-39k) to (L-39z) listed below, where the linkage to the bridge V for polypodal structures of the formula (L-39) is via the position identified by

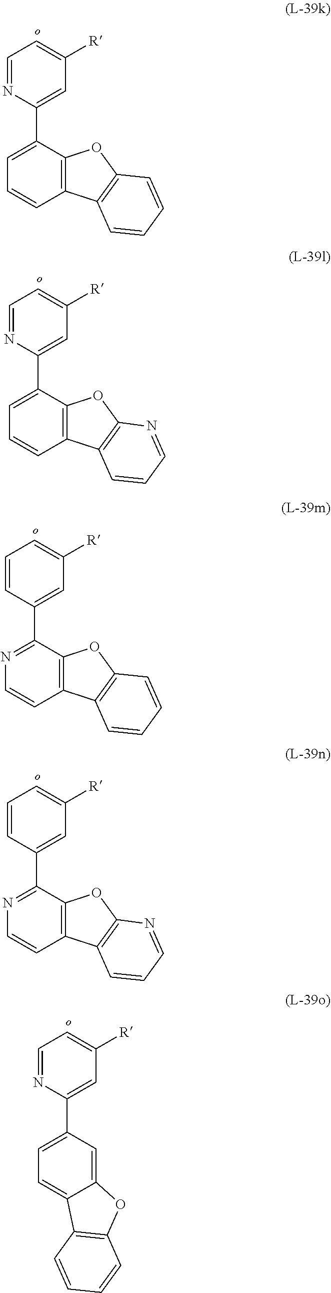

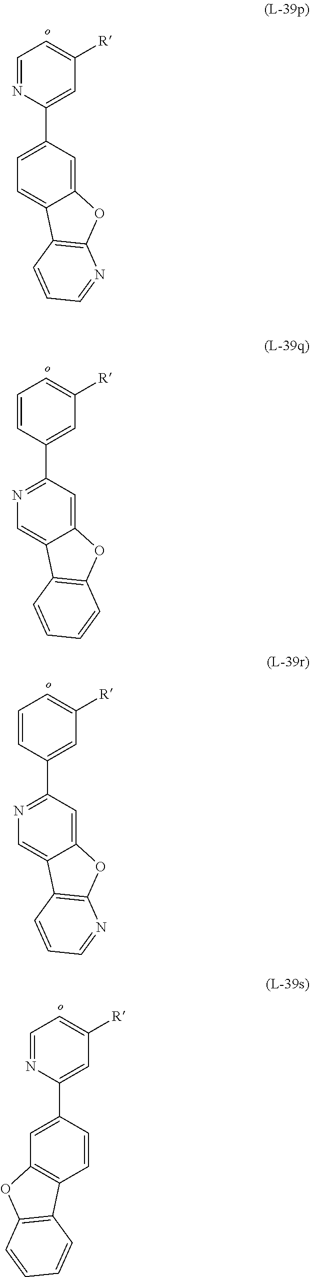

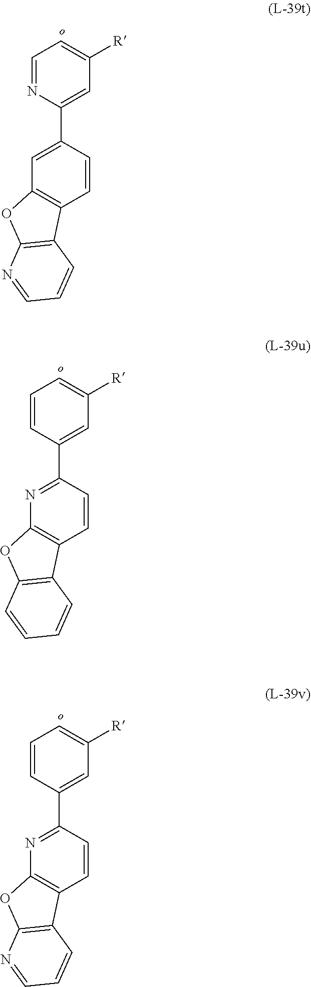

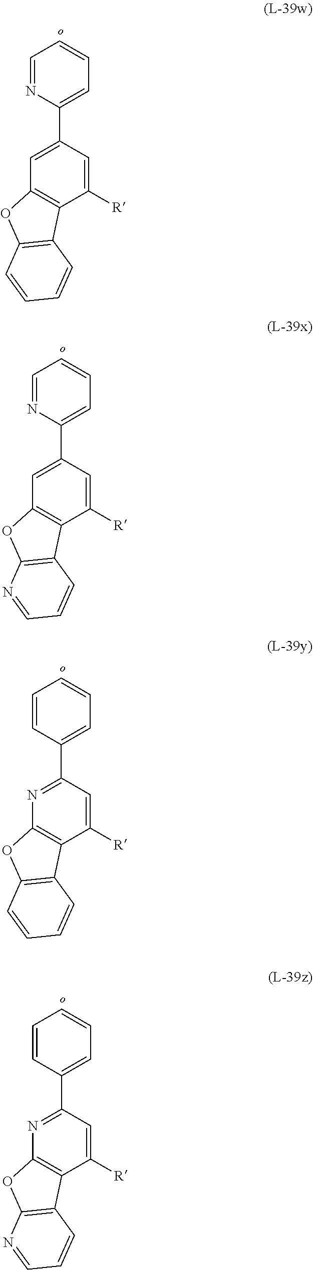

where the ligands may each also be substituted by one or more further R radicals and the fused-on structure may be substituted by one or more R¹ radicals. Preferably, there are no further R or R¹ radicals present. It is likewise possible for O in these structures to be replaced by S or NR¹.

As described above, R′ is a group of the formula (17) or (18). The two groups here differ merely in that the group of the formula (17) is bonded to the ligand or subligand L or L′ in the para position and the group of the formula (18) in the meta position.

In a preferred embodiment of the invention, n=0, 1 or 2, preferably 0 or 1 and most preferably 0.

In a further preferred embodiment of the invention, both substituents R″ bonded in the ortho positions to the carbon atom by which the group of the formula (17) or (18) is bonded to the phenylpyridine ligands are the same or different and are H or D.

Preferred embodiments of the structure of the formula (17) are the structures of the formulae (17a) to (17h), and preferred embodiments of the structure of the formula (18) are the structures of the formulae (18a) to (18h):

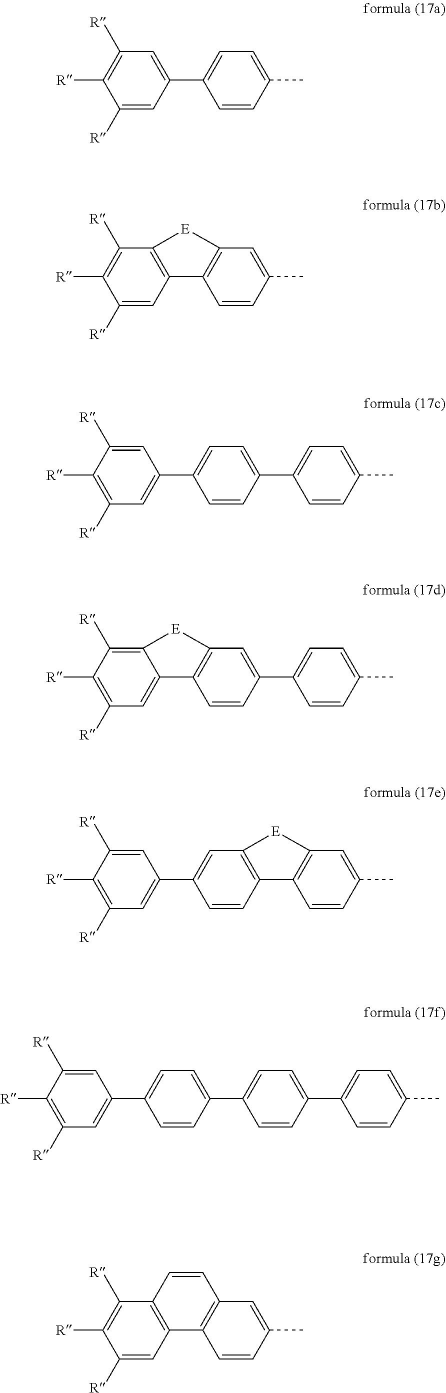

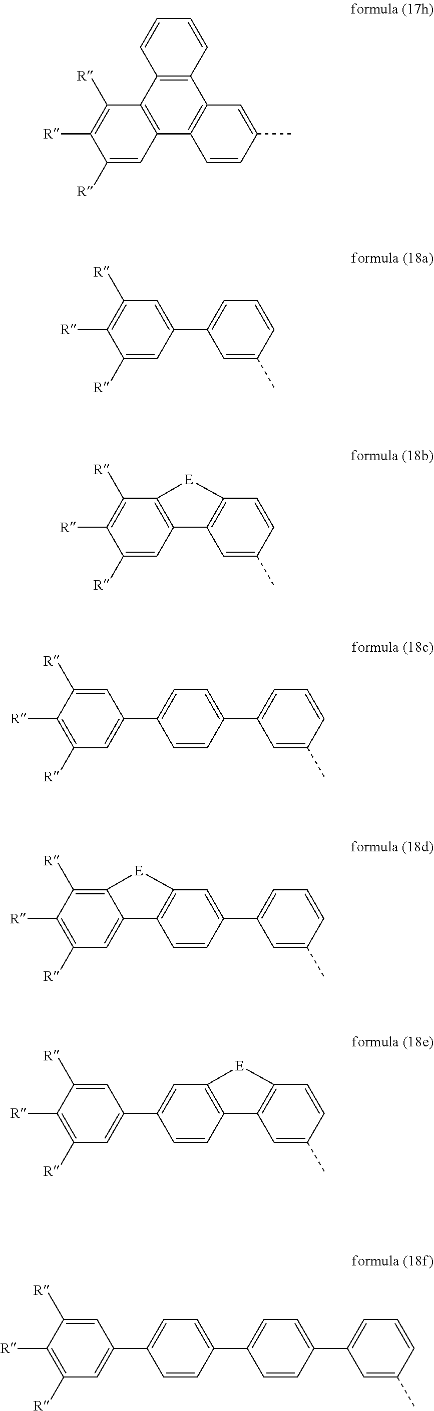

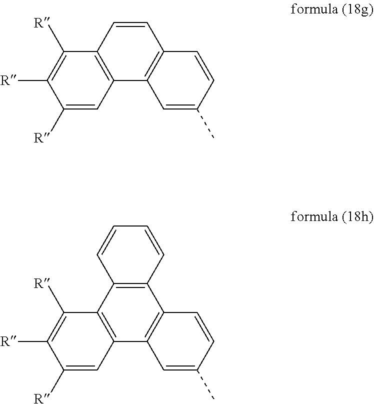

where E is C(R¹)₂, NR¹, 0 or S and the further symbols used have the definitions given above. R¹ here, when E=C(R¹)₂, is preferably the same or different at each instance and is an alkyl group having 1 to 6 carbon atoms, preferably having 1 to 4 carbon atoms, more preferably methyl. In addition, when E=NR¹, R¹ is preferably an aromatic or heteroaromatic ring system having 5 to 30 aromatic ring atoms, preferably having 6 to 24 aromatic ring atoms, more preferably having 6 to 12 aromatic ring atoms, especially phenyl.

Preferred substituents R″ on the groups of the formula (17) or (18) or the preferred embodiments are selected from the group consisting of H, D, CN and an alkyl group having 1 to 4 carbon atoms, more preferably H, D or methyl.

The subligands L″ are bis(bidentate) cyclometalated subligands that coordinate to both iridium atoms. In a preferred embodiment of the invention, the subligands are of the following formula (19) or (20):

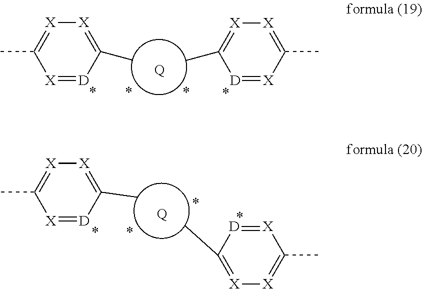

where X has the definitions given above, the dotted bond indicates the bond to V, * denotes the coordination to the iridium atom, and in addition:
D is the same or different at each instance and is C or N;
Q in formula (19) is a group of one of the following formulae (Q-1) to (Q-3), and in formula (20) is a group of one of the following formulae (Q-4) to (Q-15),

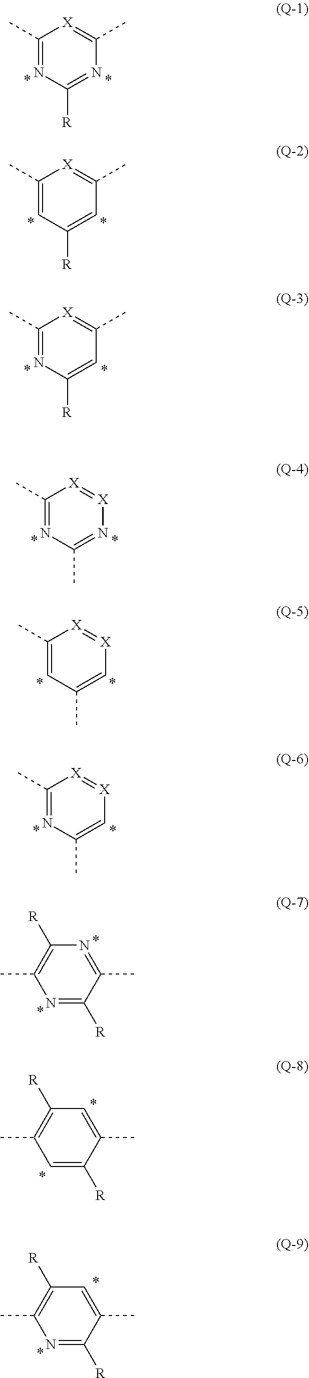

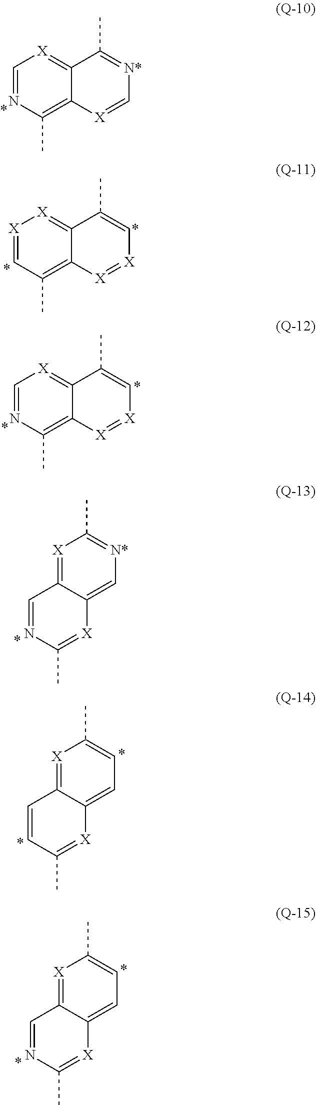

where the dotted bond in each case indicates the linkage within the formula (19) or (20), * marks the position at which this group coordinates to the iridium atoms, and X has the definitions given above.

In the formulae (Q-1) to (Q-15), preferably not more than two X groups per Q group that are not bonded directly to one another are N, and more preferably not more than one X group is N. Most preferably, all X are CR and especially CH, and all R in (Q-1) to (Q-3) and (Q-7) to (Q-9) are H or D, especially H.

For compounds of the formula (20), preference is given to the groups (Q-4), (Q-5) and (Q-7) to (Q-9).

In a preferred embodiment of the invention, the subligand of the formula (19) or (20) coordinates to each of the two iridium atoms with exactly one carbon atom and one nitrogen atom that are available as coordinating atoms in Q and as coordinating atoms D. Thus, if the Q group represents a group of the formula (Q-1), (Q-4), (Q-7), (Q-10) or (Q-13), i.e. coordinates to each of the two iridium atoms via nitrogen atoms, the two D groups are preferably carbon atoms. If the Q group represents a group of the formula (Q-2), (Q-5), (Q-8), (Q-11) or (Q-14), i.e. coordinates to each of the two iridium atoms via carbon atoms, the two D groups are preferably nitrogen atoms. If the Q group represents a group of the formula (Q-3), (Q-6), (Q-9), (Q-12) or (Q-15), i.e. coordinates to the two iridium atoms via one carbon atom and one nitrogen atom, preferably one of the two D groups is a nitrogen atom and the other D group is a carbon atom, such that each iridium atom is coordinated by one carbon atom and one nitrogen atom.

In a preferred embodiment of the present invention, in addition, the symbols X shown in formula (19) or (20) are the same or different at each instance and are CR, especially CH or CD.

If L′ is a non-cyclometalated ligand or subligand, preferred embodiments of L′ are acetylacetonate or derivatives thereof, picolinic acid or derivatives thereof, pyrazolylborates or hydroxyquinoline or derivatives thereof.

The complexes of the formulae (1) and (3) are complexes having a hexadentate or dodecadentate ligand, where the three subligands L and L′ in formula (1) are covalently bonded to one another by one bridging unit V, and the three subligands L′ and L″ in formula (3) are covalently bonded to one another by two bridging units V.

In a preferred embodiment of the invention, the bridging unit V is a group of the following formula (21), where the dotted bonds represent the position of the linkage of the subligands L or L′ in formula (1) or L′ and L″ in formula (3):

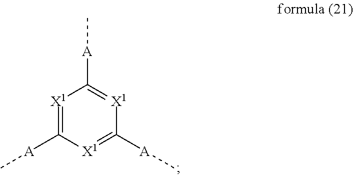

where:
X′ is the same or different at each instance and is CR or N;
X² is the same or different at each instance and is CR or N;
A is the same or different at each instance and is CR₂-CR₂, CR₂—O, CR₂—NR, C(═O)—O, C(═O)—NR or a group of the following formula (22):

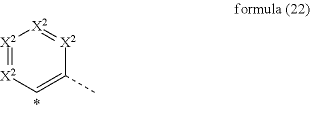

where the dotted bond in each case represents the position of the bond of the bidentate subligands L or L′ in formula (1) or L′ and L″ in formula (3) to this structure, * represents the position of the linkage of the unit of the formula (21) to the central trivalent aryl or heteroaryl group.

Preferred substituents in the group of the formula (22) when X²═CR are selected from the above-described substituents R.

In a preferred embodiment of the invention, A is the same or different at each instance and is CR₂-CR₂ or a group of the formula (22). Preference is given here to the following embodiments:
all three A groups are the same group of the formula (22);
two A groups are the same group of the formula (22), and the third A group is CR₂-CR₂,
one A group is a group of the formula (22), and the two other A groups are the same CR₂-CR₂ group; or
all three A groups are the same CR₂—CR₂ group.

What is meant here by “the same group of the formula (22)” is that these groups all have the same base skeleton and the same substitution. Moreover, what is meant by “the same CR₂—CR₂ group” is that these groups all have the same substitution.

When A is CR₂—CR₂, R is preferably the same or different at each instance and is H or D, more preferably H.

The group of the formula (22) is an aromatic or heteroaromatic six-membered ring. In a preferred embodiment of the invention, the group of the formula (22) contains not more than one heteroatom in the aryl or heteroaryl group. This does not mean that any substituents bonded to this group cannot also contain heteroatoms. In addition, this definition does not mean that formation of rings by substituents does not give rise to fused aromatic or heteroaromatic structures, for example naphthalene, benzimidazole, etc. The group of the formula (22) is preferably selected from benzene, pyridine, pyrimidine, pyrazine and pyridazine, especially benzene.

Preferred embodiments of the group of the formula (22) are the structures of the following formulae (22a) to (22h):

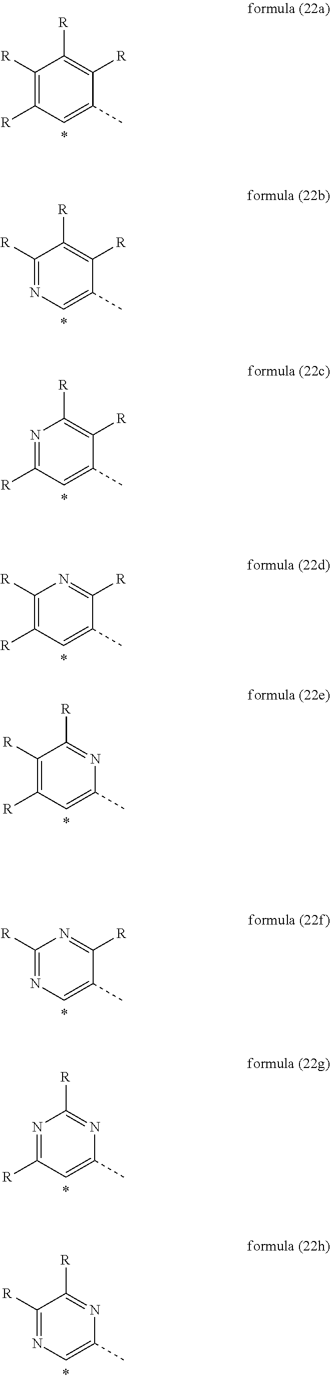

where the symbols used have the definitions given above.

Particular preference is given to the optionally substituted six-membered aromatic rings and six-membered heteroaromatic rings of the formulae (22a) to (22e). Very particular preference is given to ortho-phenylene, i.e. a group of the formula (22a).

At the same time, as also detailed above in the description of the substituents, it is also possible for adjacent substituents together to form a ring system, such that fused structures, including fused aryl and heteroaryl groups, for example naphthalene, quinoline, benzimidazole, carbazole, dibenzofuran or dibenzothiophene, can form.

Stated hereinafter are preferred embodiments of the bridgehead V, i.e. the structure of the formula (21). Preferred embodiments of the group of the formula (21) are the structures of the following formulae (23) to (26):

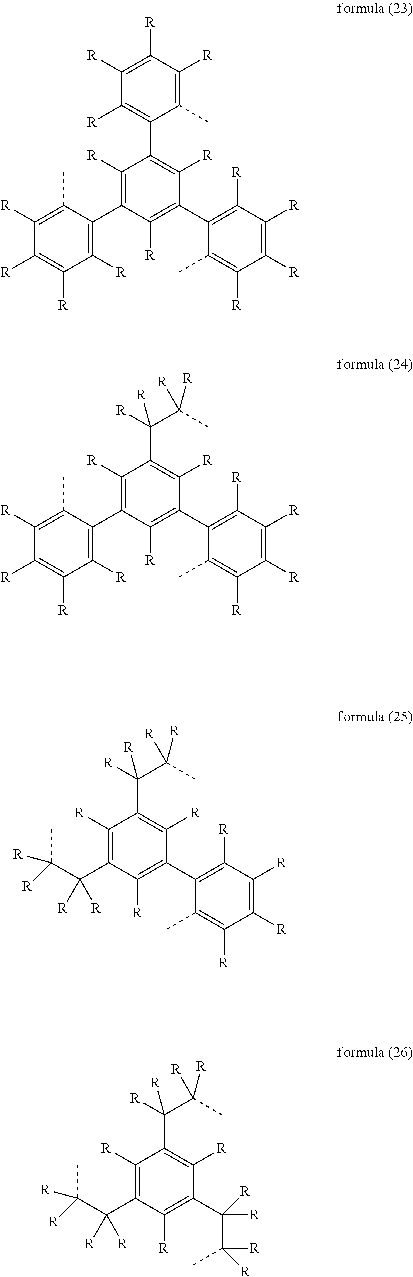

where the symbols used have the definitions given above.

More preferably, all substituents R in the central ring of the formulae (23) to (26) are H, and so the structures are preferably selected from the formulae (23a) to (26a)

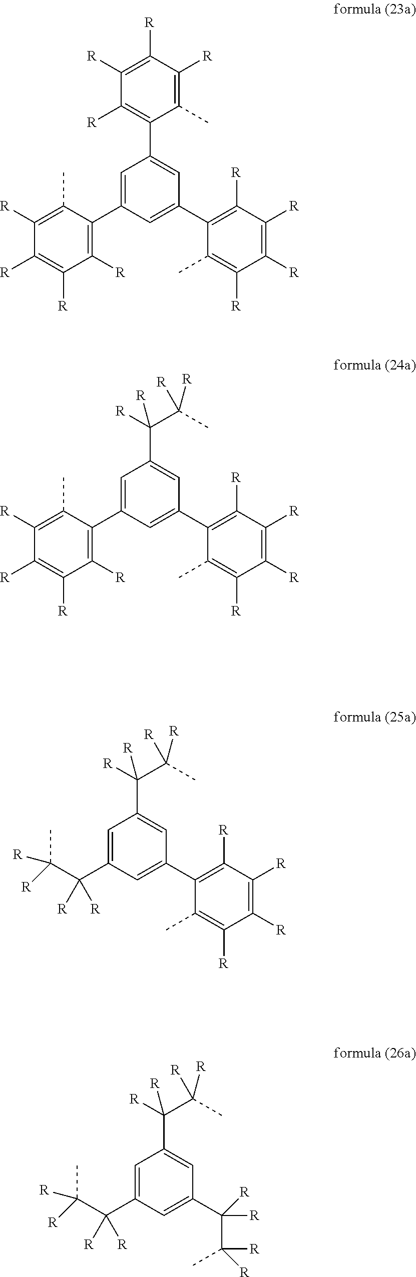

where the symbols used have the definitions given above.

More preferably, the groups of the formulae (23) to (26) are selected from the structures of the following formulae (23b) to (26b):

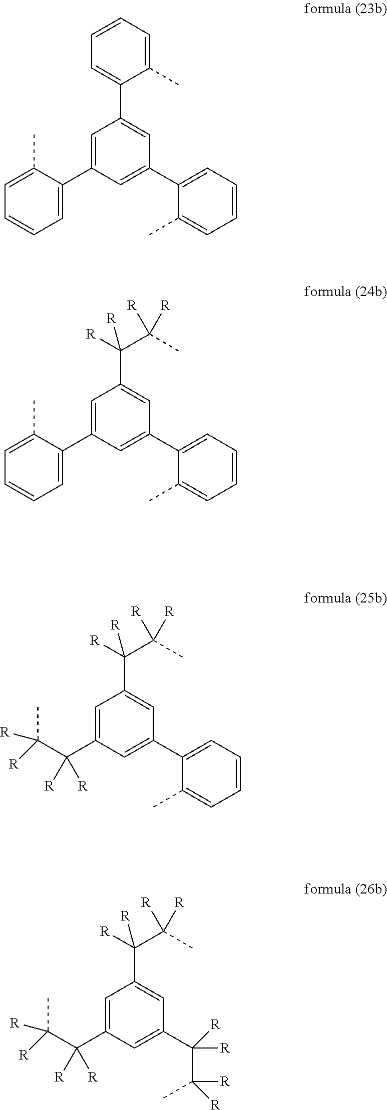

where R is the same or different at each instance and is H or D, preferably H.

Further examples of suitable bridgeheads V are the structures depicted below:

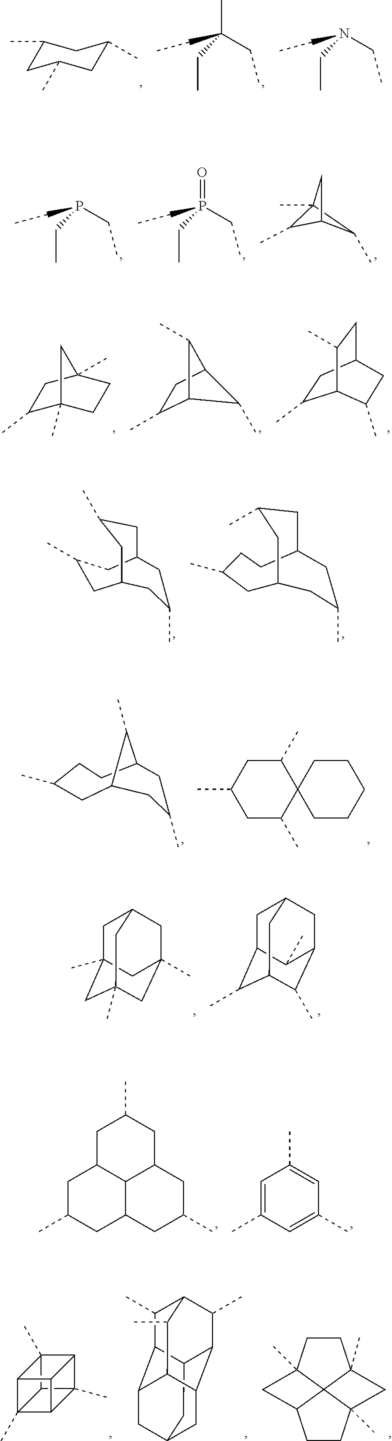

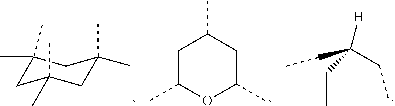

There follows a description of preferred substituents as may be present on the above-described sub-ligands L, L′ and L″, but also on the bivalent arylene or heteroarylene group in the structure of the formula (21), i.e. in the structure of the formula (22).

In one embodiment of the invention, the metal complex contains two R substituents or two R¹ substituents which are bonded to adjacent carbon atoms and together form an aliphatic ring according to one of the formulae described hereinafter. In this case, the two R substituents which form this aliphatic ring may be present on the bridge of the formula (21) and/or on one or more of the bidentate subligands or ligands. The aliphatic ring which is formed by the ring formation by two substituents R together is preferably described by one of the following formulae (27) to (33):

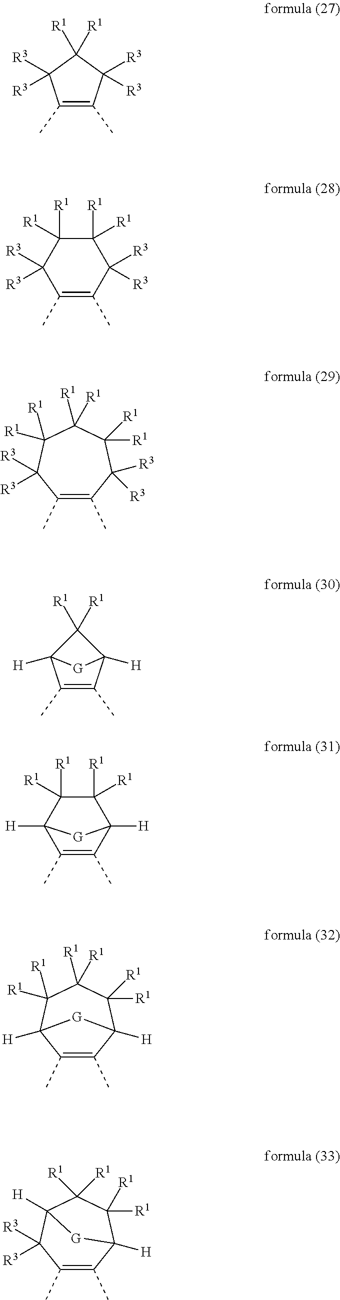

where R¹ and R² have the definitions given above, the dotted bonds signify the attachment of the two carbon atoms in the ligand, and in addition:
G is an alkylene group which has 1, 2 or 3 carbon atoms and may be substituted by one or more R² radicals, —CR²═CR²— or an ortho-bonded arylene or heteroarylene group which has 5 or 6 aromatic ring atoms and may be substituted by one or more R² radicals;
R³ is the same or different at each instance and is H, F, OR², a straight-chain alkyl group having 1 to 10 carbon atoms, a branched or cyclic alkyl group having 3 to 10 carbon atoms, where the alkyl group in each case may be substituted by one or more R² radicals, where one or more nonadjacent CH₂ groups may be replaced by R²C═CR², C≡C, Si(R²)₂, C═O, NR², O, S or CONR², or an aryl or heteroaryl group which has 5 or 6 aromatic ring atoms and may be substituted in each case by one or more R² radicals; at the same time, two R³ radicals which are bonded to the same carbon atom may together form an aliphatic ring system and thus form a spiro system; in addition, R³ with an adjacent R or R¹ radical may form an aliphatic ring system.

In the above-depicted structures of the formulae (27) to (33), a double bond is depicted in a formal sense between the two carbon atoms. This is a simplification of the chemical structure when these two carbon atoms are incorporated into an aromatic or heteroaromatic system and hence the bond between these two carbon atoms is formally between the bonding level of a single bond and that of a double bond.

Preferred embodiments of the groups of the formulae (27) to (33) can be found in patent applications WO 2014/023377, WO 2015/104045 and WO 2015/117718.

When R radicals are bonded within the bidentate ligands or subligands L, L′ or L″ or within the bivalent arylene or heteroarylene groups of the formula (22) bonded within the formula (21) or the preferred embodiments, these R radicals are the same or different at each instance and are preferably selected from the group consisting of H, D, F, Br, I, N(R¹)₂, CN, Si(R¹)₃, B(OR¹)₂, C(═O)R¹, a straight-chain alkyl group having 1 to 10 carbon atoms or an alkenyl group having 2 to 10 carbon atoms or a branched or cyclic alkyl group having 3 to 10 carbon atoms, where the alkyl or alkenyl group may be substituted in each case by one or more R¹ radicals, or an aromatic or heteroaromatic ring system which has 6 to 24 aromatic ring atoms and may be substituted in each case by one or more R¹ radicals; at the same time, two adjacent R radicals together or R together with R¹ may also form a mono- or polycyclic, aliphatic or aromatic ring system. More preferably, these R radicals are the same or different at each instance and are selected from the group consisting of H, D, F, N(R¹)₂, a straight-chain alkyl group having 1 to 6 carbon atoms or a branched or cyclic alkyl group having 3 to 10 carbon atoms, where one or more hydrogen atoms may be replaced by D or F, or an aromatic or heteroaromatic ring system which has 6 to 18 aromatic ring atoms, especially 6 to 13 aromatic ring atoms, and may be substituted by one or more R¹ radicals; at the same time, two adjacent R radicals together or R together with R¹ may also form a mono- or polycyclic, aliphatic or aromatic ring system.

Preferred R¹ radicals are the same or different at each instance and are H, D, F, N(R²)₂, CN, a straight-chain alkyl group having 1 to 10 carbon atoms or an alkenyl group having 2 to 10 carbon atoms or a branched or cyclic alkyl group having 3 to 10 carbon atoms, where the alkyl group may be substituted in each case by one or more R² radicals, or an aromatic or heteroaromatic ring system which has 6 to 24 aromatic ring atoms and may be substituted by one or more R² radicals; at the same time, two or more adjacent R¹ radicals together may form a mono- or polycyclic aliphatic ring system. Particularly preferred R¹ radicals bonded to R are the same or different at each instance and are H, F, CN, a straight-chain alkyl group having 1 to 5 carbon atoms or a branched or cyclic alkyl group having 3 to 5 carbon atoms, each of which may be substituted by one or more R² radicals, or an aromatic or heteroaromatic ring system which has 6 to 18 aromatic ring atoms, especially 6 to 13 aromatic ring atoms, and may be substituted by one or more R² radicals; at the same time, two or more adjacent R¹ radicals together may form a mono- or polycyclic aliphatic ring system.

Preferred R² radicals are the same or different at each instance and are H, F or an aliphatic hydrocarbyl radical having 1 to 5 carbon atoms or an aromatic hydrocarbyl radical having 6 to 12 carbon atoms; at the same time, two or more R² substituents together may also form a mono- or polycyclic aliphatic ring system.

The abovementioned preferred embodiments can be combined with one another as desired. In a particularly preferred embodiment of the invention, the abovementioned preferred embodiments apply simultaneously.

In general, by the process of the invention, all cyclometalated iridium complexes as used according to the prior art in organic electroluminescent devices are obtainable. For example, complexes obtainable include those as disclosed in applications WO 00/70655, WO 2001/41512, WO 2002/02714, WO 2002/15645, EP 1191613, EP 1191612, EP 1191614, WO 05/033244, WO 05/019373, US 2005/0258742, WO 2009/146770, WO 2010/015307, WO 2010/031485, WO 2010/054731, WO 2010/054728, WO 2010/086089, WO 2010/099852, WO 2010/102709, WO 2011/032626, WO 2011/066898, WO 2011/157339, WO 2012/007086, WO 2014/008982, WO 2014/023377, WO 2014/094961, WO 2014/094960, WO 2015/036074, WO 2015/104045, WO 2015/117718, WO 2016/015815, WO 2016/124304, WO 2017/032439, WO 2018/011186, WO 2018/001990, WO 2018/019687, WO 2018/019688, WO 2018/041769, WO 2018/054798, WO 2018/069196, WO 2018/069197, WO 2018/069273, WO 2018/178001, WO 2018/177981, WO 2019/020538, WO 2019/115423, WO 2019/158453, WO 2019/179909 and US 2020/0048290, and as yet unpublished application EP19156381.6.

In general, all ligands commonly used in cyclometalated complexes for use in organic electroluminescent devices can be used in the process according to the invention.

Useful iridium compounds that may be used as reactants in the process of the invention include various compounds. Preferred iridium reactants are iridium halides, especially iridium chlorides, iridium carboxylates, especially iridium acetates, iridium-COD complexes, iridium ketoketonates, and the compounds detailed hereinafter.

Preferred iridium compounds which can be used as reactant in the inventive process are the compounds of the following formulae (34) to (39),

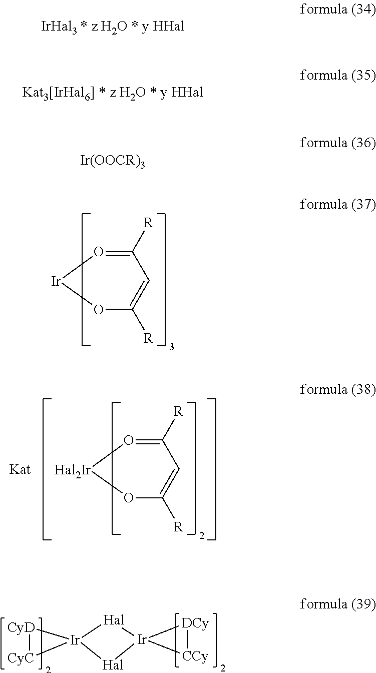

where R, CyC and CyD have the definitions given above and the other symbols used are as follows:
Hal is the same or different at each instance and is F, Cl, Br or I;
Kat is the same or different at each instance and is an alkali metal cation, an ammonium cation, a tetraalkylammonium cation having 4 to 40 carbon atoms or a tetraalkylphosphonium cation having 4 to 40 carbon atoms;
   z is 0 to 100;
   y is 0 to 100.

Also suitable are COD-iridium(I) compounds, for example [(COD)IrCl]₂ (CAS [12112-67-3]) or (COD)Ir(Ind) (CAS [102525-11-1]), where COD represents cyclooctadiene and Ind represents indenyl.

Iridium halide hydrate, especially iridium chloride hydrate, of the formula (34) is not a defined compound since it is a hygroscopic compound that may contain varying amounts of HCl and/or water. The water content of the batch is typically reported here via the iridium content. The term “iridium halide” or “iridium halide hydrate” in the context of the present invention includes all these compounds, irrespective of the amount of water and hydrogen halide present.

Iridium carboxylates of the formula (36) too, for example iridium acetate, are not a perfectly stoichiometric or defined compound, and useful compounds include various iridium carboxylates that may contain varying amounts of acetic acid, water and hydroxide, for example the compounds CAS [37598-27-9], [126310-98-3] or [52705-52-9]. The term “iridium carboxylate” in the context of the present invention includes all these compounds, regardless of their exact composition.

R in formulae (36), (37) and (38) is preferably an alkyl group having 1 to 10 carbon atoms or an aromatic or heteroaromatic ring system which has 5 to 12 aromatic ring atoms and may be substituted by one or more radicals R¹. More preferably, R in the formulae (36), (37) and (38) is an alkyl group having 1 to 5 carbon atoms, especially methyl or tert-butyl.

Preferred compounds of formula (34) are those in which the index z is 1 to 10, more preferably 2 to 4. Preferred compounds of formula (34) are also those in which the index y is 0 to 10, more preferably 0 to 3. More preferably, at the same time, z=2 to 4 and y=0 to 3.

Preferred compounds of formula (35) are those in which the index z is 0 to 10, more preferably 0 to 3. Preferred compounds of formula (35) are also those in which the index y is 0 to 10, more preferably 0 to 3, even more preferably 0. More preferably, at the same time, z=0 to 3 and y=0 to 3.

The indices z and y need not be integers, since the reactants may also comprise non-stoichiometric amounts of water and hydrogen halide. The water content in particular can vary in each batch, since hygroscopic metal salts are involved.

Preferred compounds of the formulae (34), (35), (38) and (39) are also those in which the symbol Hal is the same or different at each instance and is Cl or Br, more preferably Cl.

The process is performed in accordance with the invention in anhydrous medium in the presence of at least one carboxylic acid. A carboxylic acid is an organic compound that bears one or more carboxyl groups (—COOH). Suitable carboxylic acids are both those that are liquid at room temperature and those that are solid at room temperature but melt under reaction conditions.

A preferred embodiment of the invention involves a monocarboxylic acid of the formula R⁴—COOH or a biscarboxylic acid of the formula HOOC—R⁵—COOH. R⁴ here is selected from the group consisting of a straight-chain alkyl group having 1 to 20 carbon atoms or a branched or cyclic alkyl group having 3 to 20 carbon atoms, where the alkyl group in each case may be substituted by one or more R¹ radicals, or an alkenyl or alkyl group which has 2 to 20 carbon atoms and may be substituted by one or more R¹ radicals, an aromatic or heteroaromatic ring system which has 5 to 40 aromatic ring atoms and may be substituted in each case by one or more nonaromatic R¹ radicals, or an aralkyl or heteroaralkyl group which has 5 to 20 aromatic ring atoms and may be substituted in each case by one or more R¹ radicals. R⁵ is selected from the group consisting of a straight-chain alkylene group having 1 to 20 carbon atoms or a branched or cyclic alkylene group having 3 to 20 carbon atoms, where the alkylene group in each case may be substituted by one or more R¹ radicals, or an alkenyl or alkynyl group which has 2 to 20 carbon atoms and may be substituted by one or more R¹ radicals, a bivalent aromatic or heteroaromatic ring system which has 5 to 40 aromatic ring atoms and may be substituted in each case by one or more nonaromatic R¹ radicals, or a bivalent aralkyl or heteroaralkyl group which has 5 to 20 aromatic ring atoms and may be substituted in each case by one or more R¹ radicals. R¹ here has the definitions given above.

In a preferred embodiment of the invention, R⁴ is selected from the group consisting of a straight-chain alkyl group having 1 to 10 carbon atoms, more preferably having 1, 2, 3 or 4 carbon atoms, or a branched or cyclic alkyl group having 3 to 10 carbon atoms, more preferably having 3, 4, 5 or 6 carbon atoms, where the alkyl group may be substituted in each case by a phenyl group, or an aromatic or heteroaromatic ring system having 6 to 12 aromatic ring atoms, preferably a phenyl group that may be substituted in each case by one or more alkyl groups having 1 to 4 carbon atoms, or an aralkyl group having 6 to 12 aromatic ring atoms.

In a further preferred embodiment of the invention, R⁵ is selected from the group consisting of a straight-chain alkylene group having 1 to 10 carbon atoms, more preferably having 1, 2, 3 or 4 carbon atoms, or a branched or cyclic alkylene group having 3 to 10 carbon atoms, more preferably having 3, 4, 5 or 6 carbon atoms, where the alkylene group may be substituted in each case by a phenyl group, or a bivalent aromatic or heteroaromatic ring system having 6 to 12 aromatic ring atoms, preferably a phenylene group that may be substituted in each case by one or more alkyl groups having 1 to 4 carbon atoms, or a bivalent aralkyl group having 6 to 12 aromatic carbon atoms.

Preferred carboxylic acids are acetic acid, propionic acid, pivalic acid, benzoic acid, phenylacetic acid, adipic acid, and mixtures thereof. Particular preference is given to acetic acid, pivalic acid, benzoic acid, salicylic acid or phenylacetic acid, and mixtures thereof.

Some ligands are sparingly soluble in glacial acetic acid, for example. In this case, it is advantageous to use or to add a carboxylic acid having an aromatic structure moiety, such as benzoic acid, salicylic acid or phenylacetic acid.

Also suitable are dicarboxylic acids, for example maleic acid, fumaric acid, malonic acid, phthalic acid, isophthalic acid or terephthalic acid. Further suitable carboxylic acids are amino acids, especially α-, β-, γ-, δ- or ϵ-amino acids, for example glycine, alanine, phenylalanine or ϵ-aminocaproic acid, and hydroxycarboxylic acids, especially α-, β-, γ-, δ- or ϵ-hydroxycarboxylic acids, for example malic acid, D-, L- or meso-tartaric acid, citric acid, glycolic acid, D- or L-mandelic acid or lactic acid.

In one embodiment of the invention, the carboxylic acid or a mixture of two or more carboxylic acids is used as the sole solvent. In a further embodiment of the invention, the solvent used is a mixture of one or more carboxylic acids and one or more inert organic solvents, for example dioxane, toluene, anisole, xylene, mesitylene or various ethylene glycol ethers. What is meant here by “inert” is that the solvent does not react with the carboxylic acid used and does not have any acidic protons, especially any hydroxyl groups. The inert solvent is characterized by a pKa>15. The use of an organic solvent may be helpful in order to improve the solubility of the ligand. In addition, the use of an organic solvent simplifies the reaction regime, especially on the production scale.

The amount of carboxylic acid used is preferably 1 to 100 g per mmol of iridium reactant, more preferably 10 to 50 g per mmol of iridium reactant.

Depending on the iridium reactant, it may be preferable to add further additives to the reaction mixture.

Especially when the iridium reactant used is a hydrate, for example iridium chloride hydrate, the addition of a water scavenger may be preferable. A water scavenger in the context of the present invention is a compound that reacts chemically with water under the reaction conditions and hence removes it from the reaction mixture. It is preferable here when the water scavenger is chosen such that it reacts chemically with the water under reaction conditions with sufficient completeness that the water content of the reaction mixture (determined by Karl Fischer titration, as described, for example, in Chemie in unserer Zeit 2000, No. 3) is less than 10 ppm. The person skilled in the art generally knows which compounds react with water and hence are capable of removing water from the reaction mixture.

Suitable water scavengers are, for example, carboxylic anhydrides, carbonyl halides, especially carbonyl chlorides, trialkyl orthocarboxylates or carbodiimides, but also inorganic compounds that react with water, for example phosphorus pentoxide (P₄O₁₀), thionyl chloride or phosphoryl chloride. Examples of suitable carboxylic anhydrides and carbonyl halides are those corresponding to the carboxylic acid used in the reaction mixture, i.e., for example, acetic anhydride or acetyl chloride when acetic acid is used, pivalic anhydride or pivaloyl chloride when pivalic acid is used, benzoic anhydride or benzoyl chloride when benzoic acid is used, phenylacetic anhydride or phenylacetyl chloride when phenylacetic acid is used, etc. A further suitable carbonyl halide is oxalyl chloride. It is also possible, for example, to use acetic anhydride or acetyl chloride with simultaneous use of a higher-melting or higher-boiling carboxylic acid. It may be advisable here to distill off the acetic acid formed during the reaction. Examples of suitable trialkyl orthocarboxylates are trimethyl orthoformate and triethyl orthoacetate. One example of a suitable carbodiimide is dicyclohexylcarbodiimide (DCI). All these compounds are water scavengers in the context of the present application.

The amount of the water scavenger is preferably 3 to 30 equivalents, more preferably 5 to 20 equivalents and most preferably 10 to 20 equivalents, where the equivalents are based on the molar amount of the iridium reactant used.

In the case of anhydrous iridium reactants, the addition of a water scavenger does not offer any further benefit.

Especially when a halide is used as iridium reactant, for example iridium chloride hydrate or [(COD)IrCl]₂, the addition of a salt may also be helpful. It is suspected that this salt acts as a halide scavenger, a halide scavenger in the context of the present invention being a compound that forms a sparingly soluble salt with the halide of the iridium reactant in the reaction medium. By contrast with the prior art, however, the addition of a silver salt is not required, since many salts are sparingly soluble in the carboxylic acid, and so the formation of silver halide, which is difficult to separate off, can be avoided. Suitable halide scavengers are, for example, alkali metal, alkaline earth metal, ammonium or zinc salts, especially the corresponding salts of the carboxylic acid which is used in the reaction medium. In addition, the corresponding acetates are also suitable, even when higher-melting or higher-boiling carboxylic acids are used, in which case the acetic acid formed is preferably distilled off during the reaction. Suitable alkali metal salts are, for example, the lithium, sodium or potassium salts, preferably the sodium or potassium salts and more preferably the potassium salts. It is thus preferable, for example, to use potassium acetate when acetic acid is used, but also when other carboxylic acids are used, potassium pivalate when pivalic acid is used, potassium benzoate when benzoic acid is used, potassium salicylate when salicylic acid is used, etc. All these compounds are halide scavengers in the context of the present application.

The amount of the added salt that is used as halide scavenger is preferably 10 to 100 equivalents, more preferably 10 to 50 equivalents and most preferably 20 to 40 equivalents, where the equivalents are based on the molar amount of the iridium reactant used.

In the case of halide-free iridium reactants, the addition of a halide scavenger does not offer any further benefit.

The reaction is preferably conducted within a temperature range from room temperature to 250° C., preferably 60 to 230° C., more preferably from 80 to 200° C., even more preferably from 100 to 180° C. and especially preferably from 120 to 160° C., wherein this temperature is the jacket temperature of the reaction vessel. The reaction temperature also depends on the iridium reactant used. For instance, in the case of reactive iridium reactants, for example (COD)Ir(Ind), even reaction temperatures of <100° C. are sufficient to achieve very good yields, whereas, for example, in the case of use of iridium chloride hydrate, much better yields are achieved at reaction temperatures in the range of 120-160° C.

In a preferred embodiment of the invention, the reaction is conducted in a protective gas atmosphere, especially under nitrogen or argon.

In one embodiment of the invention, the reaction is conducted at ambient pressure under reflux. In a further embodiment, the reaction is conducted under reflux in a closed system, for example in a closed ampoule or an autoclave. The pressure here corresponds to the vapor pressure above the solution.

The preferred molar ratio of iridium to the ligand used in the reaction medium depends on the iridium reactant used and on the ligand used. When a tripodal hexadentate ligand is used for complexes of the formula (1), a ratio of Ir to the ligand of 1:0.9 to 1:5 is preferred, especially a ratio of 1:1 to 1:1.05. For complexes of the formula (2), preference is given to using a ratio of Ir to the ligand of 1:1 to 1:20, more preferably 1:3 to 1:15, most preferably 1:10 to 1:13. For complexes of the formula (3), preference is given to using a ratio of Ir to the ligand of 1.5:1 to 10:1, preferably 1.9:1 to 3:1 and most preferably 1.9:1 to 2:1.

The reaction is preferably conducted within 1 to 1000 h, more preferably within 5 to 500 h, most preferably within 10 to 200 h.

When a halogen-containing iridium reactant is used, it is further preferable when the reaction vessel used is not a steel tank, but rather, for example, reaction vessels made of glass, enamel or Teflon.

Further acceleration of the reaction can be achieved using microwave radiation. The way in which cyclometalation reactions can generally be conducted in a microwave is described, for example, in WO 2004/108738.

The workup of the reaction mixture is simple in the process of the invention, since the cyclometalated iridium compound usually precipitates out partly or completely in the reaction. This can be completed by precipitation with a solvent in which the iridium compound is insoluble, for example with an alcohol, e.g. ethanol, water, or a mixture of an alcohol and water. It may also be advisable additionally to add an organic solvent, for example toluene, xylene or dioxane, in order to dissolve excess ligand from the product. The product may then be isolated and purified by filtration and washing with a solvent in which it is insoluble, for example with water, an alcohol, e.g. ethanol, or a mixture of an alcohol and water. If necessary, further purification can be effected by the methods that are generally customary for such iridium complexes, for example recrystallization, chromatography, hot extraction, sublimation and/or heat treatment.

The complexes obtainable by the process of the invention are chiral compounds that are typically obtained in racemic form. It is also possible by the use of chiral enantiomerically pure carboxylic acids to synthesize enantiomerically enriched or enantiomerically pure complexes. Suitable examples for this purpose are the use of α-aminocarboxylic acids, a variety of which is available, for example alanine, phenylalanine, etc. Also suitable are hydroxycarboxylic acids, for example malic acid or tartaric acid.

The process of the invention offers the following advantages over the prior art:
1. The process of the invention enables access to cyclometalated iridium complexes, especially tris-cyclometalated iridium complexes, from, among other iridium reactants, also readily available iridium halide in one step and in very good yield, while many processes according to the prior art proceed from more complex reactants, for example iridium ketoketonate complexes or chloro-bridged dimeric iridium complexes, and/or achieve poorer yields.
2. The carboxylic acid used in the process of the invention can be used in a standard manner in organic production without any need for special safety measures that go beyond normal organic production.
3. Process temperatures of up to 190° C. and pressures up to 6 bar are within the customary scope in organic production, and so no special technical measures are required for the purpose. This is especially true of the reaction regime in the preferred region of about 120° C. and ambient pressure under reflux.
4. The heating and cooling times can be implemented without difficulty in customary organic production and are not process-critical.
5. The workup comprises merely typical simple process steps, such as filtration, centrifugation, washing and/or drying and purification by recrystallization, chromatography, sublimation and/or heat treatment.
6. The formation of metallic iridium in the form of an iridium mirror or iridium black is not observed. More particularly, no formation of pyrophoric elemental iridium is observed, which constitutes a considerable improvement in reaction safety.

More particularly, it follows from the advantages detailed above that the process of the invention is also of very good suitability for the preparation of cyclometalated iridium complex on the production scale and not just on the laboratory scale.

The present invention will be further illustrated by the following examples, without intending to limit it to the examples. For those skilled in the art in the field of organic and organometallic synthesis, it is possible to carry out the reactions of the invention in other systems without further inventive skill. More particularly, the process, without exercising inventive skill, can be performed on differently substituted systems or else on systems containing other aryl or heteroaryl groups as coordinating groups rather than phenyl or pyridine. The person skilled in the art will likewise be able to conduct the process of the invention with addition of carboxylic acids, other water scavengers and/or other salts.

### EXAMPLES

The syntheses which follow, unless stated otherwise, are conducted under a protective gas atmosphere in dried solvents. The metal complexes are additionally handled with exclusion of light or under yellow light. The solvents and reagents can be purchased, for example, from Sigma-ALDRICH or ABCR. The respective figures in square brackets or the numbers quoted for individual compounds relate to the CAS numbers of the compounds known from the literature. In the case of compounds that can show multiple enantiomeric, diastereomeric or tautomeric forms, one form is shown in a representative manner.

1) General Procedure

A mixture of the tripodal hexadentate ligand, the iridium reactant and the reaction medium R, and if appropriate the additive A (desiccant, water scavenger) and the additive B (carboxylate salt, used as halide scavenger), is initially charged in a closable pressure-resistant reaction vessel (e.g. crimp neck bottle with septum cap) under argon atmosphere and heated in a heating block to the specified temperature (=heating block temperature). Samples are taken at the times specified and analyzed via ¹H NMR spectroscopy and/or HPLC. For ¹H NMR spectroscopy analysis, 2 drops of the reaction mixture are diluted with 0.75 ml of DMSO-D6, and the mixture is heated until a clear solution has formed, and then analyzed as usual. Subsequently, the spectrum of the reaction mixture is compared with spectra of the corresponding ligand and of the complex in DMSO-D6 and quantified via integration. The error of this method is estimated as +/−5%. The HPLC is conducted by the established standard method (HPLC column: Chromolith-Performance RP-18e, 100-4.6 mm, gradient: water-acetonitrile, detection 254 nm). The conversions reported are based on area % of the ligand peak and the complex peak. The experiments specified hereinafter are conducted with the molar amount 1 eq=100 μmol.

The results are collated in table 1. The individual headings each show which parameter was varied. The abbreviations are elucidated below the table.

TABLE 1

| | | | | | | | | |
|---|---|---|---|---|---|---|---|---|
| | | | | | R | | | |
| | | | | | [g/mmol | Temp. | Time | Conversion |
| Ex. | Ligand | Ir reactant | A | B | Ir reactant] | [° C.] | [h] | [%] |

Variation of the reaction medium R

| | | | | | | | | |
|---|---|---|---|---|---|---|---|---|
| 1 | L1 | IrCl₃ × H₂O | — | — | HOAc | 120 | 60 | <10% |
| | 1 eq | 1 eq: | | | 30 | | | |
| 2 | L1 | IrCl₃ × H₂O | — | — | HOPiv | 160 | 60 | <15% |
| | 1 eq: | 1 eq: | | | 30 | | | |
| 3 | L1 | IrCl₃ × H₂O | — | — | HOBnz | 160 | 60 | <15% |
| | 1 eq: | 1 eq: | | | 30 | | | |

Addition of water scavenger (additive A)

| | | | | | | | | |
|---|---|---|---|---|---|---|---|---|
| 4 | L1 | IrCl₃ × H₂O | Ac₂O | — | HOAc | 120 | 60 | <30% |
| | 1 eq: | 1 eq: | 10 eq: | | 30 | | | |

Addition of carboxylate (additive B)

| | | | | | | | | |
|---|---|---|---|---|---|---|---|---|
| 5 | L1 | IrCl₃ × H₂O | — | KOAc | HOAc | 120 | 60 | <20% |
| | 1 eq: | 1 eq: | | 30 eq: | 30 | | | |

Variation of the carboxylate (additve B)-different amounts and counterions

| | | | | | | | | |
|---|---|---|---|---|---|---|---|---|
| 6 | L1 | IrCl₃ × H₂O | Ac₂O | LiOAc | HOAc | 120 | 60 | <30% |
| | 1 eq: | 1 eq: | 10 eq: | 30 eq: | 30 | | | |
| 7 | L1 | IrCl₃ × H₂O | Ac₂O | LiOAc | HOAc | 120 | 120 | <30% |
| | 1 eq: | 1 eq: | 10 eq: | 30 eq: | 30 | | | |
| 8 | L1 | IrCl₃ × H₂O | Ac₂O | NaOAc | HOAc | 120 | 60 | ~40% |
| | 1 eq: | 1 eq: | 10 eq: | 30 eq: | 30 | | | |
| 9 | L1 | IrCl₃ × H₂O | Ac₂O | NaOAc | HOAc | 120 | 120 | ~70% |
| | 1 eq: | 1 eq: | 10 eq: | 30 eq: | 30 | | | |
| 10 | L1 | IrCl₃ × H₂O | Ac₂O | KOAc | HOAc | 120 | 60 | ~50% |
| | 1 eq: | 1 eq: | 10 eq: | 30 eq: | 30 | | | |
| 11 | L1 | IrCl₃ × H₂O | Ac₂O | KOAc | HOAc | 120 | 120 | ~80% |
| | 1 eq: | 1 eq: | 10 eq: | 30 eq: | 30 | | | |
| 12 | L1 | IrCl₃ × H₂O | Ac₂O | Zn(OAC)₂ | HOAc | 120 | 60 | ~30% |
| | 1 eq: | 1 eq: | 10 eq: | 15 eq: | 30 | | | |
| 13 | L1 | IrCl₃ × H₂O | Ac₂O | NH₄OAc | HOAc | 120 | 60 | ~60% |
| | 1 eq: | 1 eq: | 10 eq: | 15 eq: | 30 | | | |

Reaction time/completeness progression: Ex. 10 → Ex. 11 → Ex. 14

| | | | | | | | | |
|---|---|---|---|---|---|---|---|---|
| 14 | L1 | IrCl₃ × H₂O | Ac₂O | KOAc | HOAc | 120 | 240 | ~95% |
| | 1 eq: | 1 eq: | 10 eq: | 30 eq: | 30 | | | |

Reaction temperature: Ex. 10 → Ex. 15

| | | | | | | | | |
|---|---|---|---|---|---|---|---|---|
| 15 | L1 | IrCl₃ × H₂O | Ac₂O | KOAc | HOAc | 160 | 48 | ~95% |
| | 1 eq: | 1 eq: | 10 eq: | 30 eq: | 30 | A.P. | | |

Amount of additive A (water scavenger): Ex. 11 → Ex. 16 → Ex. 17 → Ex. 18

| | | | | | | | | |
|---|---|---|---|---|---|---|---|---|
| 16 | L1 | IrCl₃ × H₂O | Ac₂O | KOAc | HOAc | 120 | 120 | ~30% |
| | 1 eq: | 1 eq: | 1 eq: | 30 eq: | 30 | | | |
| 17 | L1 | IrCl₃ × H₂O | Ac₂O | KOAc | HOAc | 120 | 120 | ~60% |
| | 1 eq: | 1 eq: | 3 eq: | 30 eq: | 30 | | | |
| 18 | L1 | IrCl₃ × H₂O | Ac₂O | KOAc | HOAc | 120 | 120 | ~80% |
| | 1 eq: | 1 eq: | 30 eq: | 30 eq: | 30 | | | |

Amount of additive B: Ex. 11 → Ex. 19 → Ex. 20 → Ex. 21

| | | | | | | | | |
|---|---|---|---|---|---|---|---|---|
| 19 | L1 | IrCl₃ × H₂O | Ac₂O | KOAc | HOAc | 120 | 120 | ~40% |
| | 1 eq: | 1 eq: | 10 eq: | 3 eq: | 30 | | | |
| 20 | L1 | IrCl₃ × H₂O | Ac₂O | KOAc | HOAc | 120 | 120 | ~65% |
| | 1 eq: | 1 eq: | 10 eq: | 10 eq: | 30 | | | |
| 21 | L1 | IrCl₃ × H₂O | Ac₂O | KOAc | HOAc | 120 | 120 | ~85% |
| | 1 eq: | 1 eq: | 10 eq: | 50 eq: | 30 | | | |

Variation of reaction medium: Ex. 10 → Ex. 22 → Ex. 23 A.P.

| | | | | | | | | |
|---|---|---|---|---|---|---|---|---|
| 22 | L1 | IrCl₃ × H₂O | Ac₂O | KOAc | HOPiv | 160 | 48 | ~98% |
| | 1 eq: | 1 eq: | 10 eq: | 30 eq: | 30 | A.P. | | |
| 23 | L1 | IrCl₃ × H₂O | Ac₂O | KOAc | HOBnz | 160 | 48 | ~98% |
| | 1 eq: | 1 eq: | 10 eq: | 30 eq: | 30 | A.P. | | |
| 24 | L1 | IrCl₃ × H₂O | Ac₂O | KOAc | HOPhe | 160 | 48 | ~99% |
| | 1 eq: | 1 eq: | 10 eq: | 30 eq: | 30 | A.P. | | |

Optimization of additive A, additive B, reaction medium R:
Ex. 10 → Ex. 25 → Ex. 26 → Ex. 27 → Ex. 28 → Ex. 29-ambient pressure

| | | | | | | | | |
|---|---|---|---|---|---|---|---|---|
| 25 | L1 | IrCl₃ × H₂O | Ac₂O | KOAc | HOAc | 127 | 120 | ~95% |
| | 1 eq: | 1 eq: | 10 eq: | 30 eq: | 30 | V.A. | | |
| 26 | L1 | IrCl₃ × H₂O | Ac₂O | KOAc | HOPiv | 154 | 72 | ~95% |
| | 1 eq: | 1 eq: | 10 eq: | 30 eq: | 30 | V.A. | | |
| 27 | L1 | IrCl₃ × H₂O | Piv₂O | KOPiv | HOPiv | 163 | 48 | ~98% |
| | 1 eq: | 1 eq: | 10 eq: | 30 eq: | 30 | V.A. | | |
| 28 | L1 | IrCl₃ × H₂O | Bnz₂O | KOBnz | HOBnz | 165 | 48 | ~98% |
| | 1 eq: | 1 eq: | 10 eq: | 30 eq: | 30 | V.A. | | |
| 29 | L1 | IrCl₃ × H₂O | Ac₂O | KOAc | HOPhe | 135 | 24 | ~98% |
| | 1 eq: | 1 eq: | 10 eq: | 30 eq: | 30 | V.A. | | |

Variation of Ir source

| | | | | | | | | |
|---|---|---|---|---|---|---|---|---|
| 30 | L1 | Ir(OAc)₃ | — | — | HOAc | 120 | 60 | ~70% |
| | 1 eq: | 1 eq: | | | 30 | | | |
| 31 | L1 | Ir(OAc)₃ | — | — | HOAc | 120 | 240 | ~85% |
| | 1 eq: | 1 eq: | | | 30 | | | |
| 32 | L1 | Ir(OAc)₃ | — | KOAc | HOAc | 120 | 60 | ~80% |
| | 1 eq: | 1 eq: | | 30 eq: | 30 | | | |
| 33 | L1 | Ir(OAc)₃ | — | — | HOPiv | 160 | 48 | ~60% |
| | 1 eq: | 1 eq: | | | 30 | | | |
| 34 | L1 | Ir(OAc)₃ | — | — | HOPiv | 160 | 200 | ~90% |
| | 1 eq: | 1 eq: | | | 30 | | | |
| 35 | L1 | [Ir(COD)Cl)₂ | — | KOAc | HOAc | 120 | 60 | ~90% |
| | 1 eq: | 0.5 eq: | | 30 eq: | 30 | | | |
| 36 | L1 | (Ind)Ir(COD) | — | — | HOAc | 120 | 12 | ~95% |
| | 1 eq: | 1 eq: | | | 30 | | | |
| 37 | L1 | (Ind)Ir(COD) | — | — | HOAc | 80 | 12 | ~95% |
| | 1 eq: | 1 eq: | | | 30 | | | |

Variation of water scavenger (desiccant) A: Ex. 11 → Ex. 38, 39, 40, 41

| | | | | | | | | |
|---|---|---|---|---|---|---|---|---|
| 38 | L1 | IrCl₃ × H₂O | AcCl | KOAc | HOAc | 120 | 120 | ~75% |
| | 1 eq: | 1 eq: | 10 eq: | 30 eq: | 30 | A.P. | | |
| 39 | L1 | IrCl₃ × H₂O | TMOF | KOAc | HOAc | 120 | 120 | ~85% |
| | 1 eq: | 1 eq: | 10 eq: | 30 eq: | 30 | A.P. | | |
| 40 | L1 | IrCl₃ × H₂O | TEOA | KOAc | HOAc | 120 | 120 | ~85% |
| | 1 eq: | 1 eq: | 10 eq: | 30 eq: | 30 | A.P. | | |
| 41 | L1 | IrCl₃ × H₂O | P₄O₁₀ | KOAc | HOAc | 120 | 120 | ~85% |
| | 1 eq: | 1 eq: | 5 eq: | 30 eq: | 30 | A.P. | | |

Variation of ligands: Ex. 27 → Ex. 42-52 & Ex. 24 → Ex. 54

| | | | | | | | | |
|---|---|---|---|---|---|---|---|---|
| 42 | L2 | IrCl₃ × H₂O | Piv₂O | KOPiv | HOPiv | 160 | 48 | ~95% |
| | 1 eq: | 1 eq: | 10 eq: | 30 eq: | 30 | | | |
| 43 | L3 | IrCl₃ × H₂O | Piv₂O | KOPiv | HOPiv | 160 | 48 | ~95% |
| | 1 eq: | 1 eq: | 10 eq: | 30 eq: | 30 | | | |
| 44 | L4 | IrCl₃ × H₂O | Piv₂O | KOPiv | HOPiv | 160 | 48 | ~95% |
| | 1 eq: | 1 eq: | 10 eq: | 30 eq: | 30 | | | |
| 45 | L5 | IrCl₃ × H₂O | Piv₂O | KOPiv | HOPiv | 160 | 36 | ~95% |
| | 1 eq: | 1 eq: | 10 eq: | 30 eq: | 30 | | | |
| 46 | L6 | IrCl₃ × H₂O | Piv₂O | KOPiv | HOPiv | 160 | 24 | ~95% |
| | 1 eq: | 1 eq: | 10 eq: | 30 eq: | 30 | | | |
| 47 | L4 | IrCl₃ × H₂O | Bnz₂O | KOBnz | HOBnz | 160 | 48 | ~95% |
| | 1 eq: | 1 eq: | 10 eq: | 30 eq: | 30 | | | |
| 48 | L5 | IrCl₃ × H₂O | Bnz₂O | KOBnz | HOBnz | 160 | 48 | ~95% |
| | 1 eq: | 1 eq: | 10 eq: | 30 eq: | 30 | | | |
| 49 | L6 | (Ind)Ir(COD) | — | — | HOAc | 100 | 30 | ~95% |
| | 1 eq | | | | 30 | | | |
| 50 | L6 | IrCl₃ × H₂O | Ac₂O | KOAc | HOPiv | 154 | 60 | ~95% |
| | 1 eq | | 10 eq: | 3 eq: | 30 | V.A. | | |
| 51 | L7 | IrCl₃ × H₂O | Ac₂O | KOAc | HOPiv | 154 | 48 | ~95% |
| | 1 eq: | 1 eq: | 10 eq: | 30 eq: | 30 | V.A. | | |
| 52 | L8 | IrCl₃ × H₂O | Ac₂O | KOAc | HOPiv | 153 | 48 | ~95% |
| | 1 eq: | 1 eq: | 10 eq: | 30 eq: | 30 | V.A. | | |
| 53 | L9 | IrCl₃ × H₂O | Piv20 | KOPiv | HOPiv | 163 | 24 | ~95% |
| | 1 eq: | 1 eq: | 10 eq: | 30 eq: | 30 | V.A. | | |
| 54a | L10 | IrCl₃ × H₂O | Ac₂O | KOAc | HOPhe | 160 | 80 | ~95% |
| | 1 eq: | 1 eq: | 10 eq: | 30 eq: | 30 | A.P. | 1 | |
| 54b | L10 | IrCl₃ × H₂O | Ac₂O | KOAc | HOPhe | 160 | 80 | ~95% |
| | 1 eq: | 1 eq: | 10 eq: | 30 eq: | 30 | A.P. | 2 | |
| | | | | L-alanine | | | | |
| | | | | 100 eq: | | | | |
| 57 | L11 | IrCl₃ × H₂O | Ac₂O | KOAc | HOPiv | 154 | 80 | ~95% |
| | 1 eq: | 1 eq: | 10 eq: | 30 eq: | 30 | V.A. | | |
| 58 | L12 | IrCl₃ × H₂O | Ac₂O | KOAc | HOPiv | 154 | 80 | ~95% |
| | 1 eq: | 1 eq: | 10 eq: | 30 eq: | 30 | V.A. | | |
| 59 | L13 | IrCl₃ × H₂O | Ac₂O | KOAc | HOPiv | 154 | 55 | ~83% |
| | 1 eq: | 1 eq: | 10 eq: | 30 eq: | 30 | V.A. | | |
| 60 | L14 | IrCl₃ × H₂O | Ac₂O | KOAc | HOPiv | 154 | 55 | ~95% |
| | 1 eq: | 1 eq: | 10 eq: | 30 eq: | 30 | V.A. | | |
| 61 | L15 | IrCl₃ × H₂O | Ac₂O | KOAc | HOPiv | 154 | 55 | ~95% |
| | 1 eq: | 1 eq: | 10 eq: | 30 eq: | 30 | V.A. | | |
| 62 | L16 | IrCl₃ × H₂O | Ac₂O | KOAc | HOPiv | 154 | 55 | ~90% |
| | 1 eq: | 1 eq: | 10 eq: | 30 eq: | 30 | V.A. | | |

Addition of inert solvent: Ex. 11 → Ex. 55, 56

| | | | | | | | | |
|---|---|---|---|---|---|---|---|---|
| 55 | L1 | IrCl₃ × H₂O | Ac₂O | KOAc | HOAc | 120 | 80 | ~80% |
| | 1 eq: | 1 eq: | 10 eq: | 30 eq: | 30 | | | |
| | | | | | Toluene | | | |
| | | | | | 15 | | | |
| 56 | L1 | IrCl₃ × H₂O | Ac₂O | KOAc | HOAc | 120 | 100 | ~85% |
| | 1 eq: | 1 eq: | 10 eq: | 30 eq: | 30 | | | |
| | | | | | Dioxane | | | |
| | | | | | 15 | | | |

```
1) Δ,Δ-/Λ,Λ- & Δ,Λ-diastereomer mixture about 1:1
2) Addition of 100 eq alanine for chiral induction, Δ,Δ-/Λ,Λ- & Δ,Λ-diastereomer mixture about 1:4
Abbreviations:
HOAc: anhydrous acetic acid, glacial acetic acid [64-19-7]
HOPiv: pivalic acid [75-98-9]
HOBnz: benzoic acid [65-85-0]
HOPhe: phenylacetic acid [103-82-2]
Ac₂O: acetic anhydride [108-24-7]
  pivalic anhydride [1538-75-6]
Bnz₂O: benzoic anhydride [93-97-0]
AcCl: acetyl chloride [75-36-5]
TMOF: trimethyl orthoformate [149-73-5]
TEOA: triethyl orthoacetate [78-39-7]
P₄O₁₀: tetraphosphorus decao×ide [1314-56-3]
LiOAc: lithium acetate, anhydrous [546-89-4]
NaOAc: sodium acetate, anhydrous [127-09-3]
KOAc: potassium acetate, anhydrous [127-08-2]
NH₄OAc: ammonium acetate [631-61-8]
Zn(OAc)₂: zinc acetate, anhydrous [557-34-6]
  potassium pivalate, anhydrous [19455-23-3]
KOBnz: potassium benzoate, anhydrous [582-25-2]
L-alanine: L-alanine [56-41-7]
```

IrCl₃×H₂O: iridium trichloride hydrate, in the context of the invention a collective term for the compounds listed below, with the stoichiometry adjusted according to the Ir content of the compound used:

IrCl₃×3 H₂O: [13569-57-8]
IrCl₃×XH₂O: [14996-61-3]
IrCl₃×4H₂O: [16938-21-9]
IrCl₃×1H₂O: [1542203-90-6]
IrCl₃×2H₂O: [1593479-74-3]
IrCl₃×HCl×H₂O: [717927-65-6]

Ir(OAc)₃: iridium acetate, in the context of the invention a collective term for the compounds listed below, with the stoichiometry adjusted according to the Ir content of the compound used:

### Ir(OAc)_{X}: [37598-27-9]

[Ir₃Cl₂H₂₄O₁₆]CH₃O₂: [52705-52-8]
[Ir(COD)Cl)₂: cyclo-1,5-octadienyliridium(I) chloride dimer [12112-67-3]
(Ind)Ir(COD): (1,5-cyclooctadiene)(η5-indenyl)(η5-iridium(I) [102525-11-1]
A. P.: in a closed reaction vessel under the autogenous pressure of the reaction mixture at the stated temperature
V. A.: versus atmosphere, crimped neck bottle blanketed with argon versus laboratory atmosphere, temperature figure: temperature measured in the reaction mixture

Performance of the Process on a Preparative Scale, Using the Example of L1:

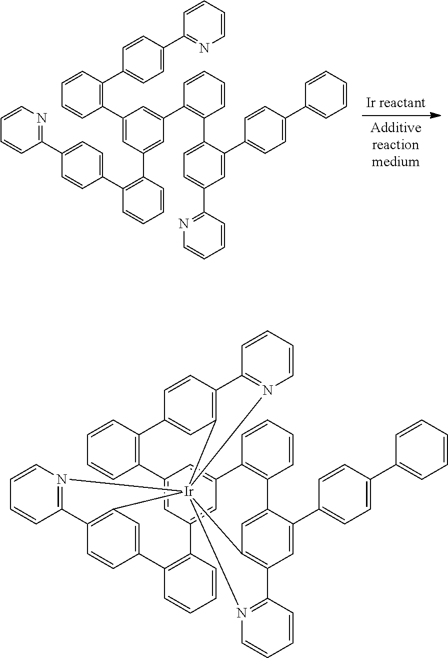

A: In Glacial Acetic Acid with Acetic Anhydride and Potassium Acetate

A stirred autoclave with Teflon insert under an argon atmosphere is charged with 9.18 g (10 mmol) of ligand L1, 3.53 g (10 mmol) of IrCl₃×3 H₂O, 29.45 g (300 mmol) of potassium acetate, anhydrous, 300 ml of glacial acetic acid and 9.47 ml (100 mmol) of acetic anhydride, closed and heated to 160° C. with good stirring for 48 h (pressure: 4.3 bar). After cooling, the yellow suspension is poured into 1000 ml of demineralized water while stirring, and the yellow solid is filtered off with suction, washed three times with 200 ml each time of water and twice with 50 ml each time of ethanol, and dried under reduced pressure. The solid is suspended in 300 ml of warm dichloromethane (DCM) for 1 h and then chromatographed with DCM on 300 g of silica gel 60, Merck. The yellow main fraction (Rf˜0.9) is selected, and the DCM is distilled off on a rotary evaporator at water bath temperature 50° C. under standard pressure, continuously replacing the volume of DCM distilled off by addition of EtOH. After the DCM distillation has ended, the mixture is concentrated to a volume of about 100 ml under reduced pressure, the yellow solid is filtered off by means of a double-ended frit, and the residue is washed twice with 50 ml of ethanol each time and dried first in an argon stream and then under reduced pressure (p˜10⁻³ mbar, T˜100° C.). Yield: 10.19 g (9.20 mmol); 92% of theory; purity: >99.5% by ¹H NMR and HPLC. The product thus obtained can, as described in WO 2016/124304, be purified further by means of hot extraction and fractional sublimation.

B: In Pivalic Acid with Pivalic Anhydride and Potassium Pivalate

Procedure as described under A), except using pivalic acid rather than acetic acid, pivalic anhydride rather than acetic anhydride and potassium pivalate rather than potassium acetate, and conducting the reaction in a 2 l four-neck round-bottom flask with precision glass stirrer, reflux condenser and argon blanketing. Internal temperature˜165° C. Yield: 10.44 g (9.43 mmol); 94% of theory; purity: >99.5% by ¹H NMR and HPLC.

C: In Pivalic Acid with Acetic Anhydride and Potassium Acetate

Procedure as described under B), except using acetic anhydride rather than pivalic anhydride and potassium acetate rather than potassium pivalate, and conducting the reaction in a 2 l four-neck round-bottom flask with precision glass stirrer, water separator, reflux condenser and argon blanketing. The acetic acid that collects in the water separator is discharged from time to time. Internal temperature˜155° C. Yield: 10.51 g (9.50 mmol); 95% of theory; purity: >99.5% by ¹H NMR and HPLC.

D: In Benzoic Acid with Benzoic Anhydride and Potassium Benzoate

Procedure as described under A), except using benzoic acid rather than acetic acid, benzoic anhydride rather than acetic anhydride and potassium benzoate rather than potassium acetate, and conducting the reaction in a 2 l four-neck round-bottom flask with precision glass stirrer, reflux condenser and argon blanketing. Internal temperature˜168° C. For the workup, the warm, still-liquid reaction mixture is poured into water. Yield: 10.51 g (9.49 mmol); 95% of theory; purity: >99.5% by ¹H NMR and HPLC.

In Phenylacetic Acid with Acetic Anhydride and Potassium Acetate

Procedure as described under C), using phenylacetic acid rather than pivalic acid. Internal temperature˜152° C. For the workup, the warm, still-liquid reaction mixture is poured into water. Yield: 10.84 g (9.80 mmol); 98% of theory; purity: >99.5% by ¹H NMR and HPLC.

With Ir(OAc)₃ in Salicylic Acid/Mesitylene

A 500 ml four-neck flask with precision glass stirrer, water separator (10 ml reservoir), reflux condenser and argon blanketing is charged under an argon atmosphere with 9.18 g (10 mmol) of ligand L1, 3.69 g (10 mmol) of iridium(III) acetate Ir(OAc)₃, 40 g of salicylic acid and 40 ml of mesitylene, and heated under gentle reflux (internal temperature about 158° C.) for 22 h. The initially blue solution becomes a yellow suspension with time; some acetic acid also separates out at the start, which is discharged. After 22 h, the mixture is allowed to cool to 90° C., 200 ml of ethanol is cautiously added dropwise, the mixture is allowed to cool to 40° C. while stirring, and the yellow solid is filtered off with suction, washed three times with 30 ml of methanol each time and dried under reduced pressure. Further purification as described under A. Yield: 10.86 g (9.20 mmol); 98% of theory; purity: >99.5% by ¹H NMR and HPLC. The product thus obtained can, as described in WO 2016/124304, be purified further by means of hot extraction and fractional sublimation.

Rather than mesitylene, it is also possible to use anisole.

Ligands:

Table 2 shows the ligands used.

TABLE 2

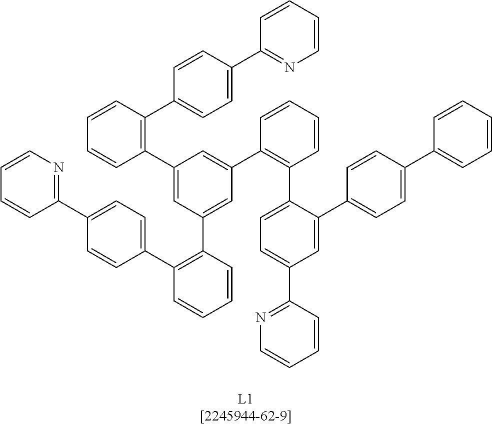 [SMILES: c1ccc(-c2ccc(-c3cc(-c4ccccn4)ccc3-c3ccccc3-c3cc(-c4ccccc4-c4ccc(-c5ccccn5)cc4)cc(-c4ccccc4-c4ccc(-c5ccccn5)cc4)c3)cc2)cc1]

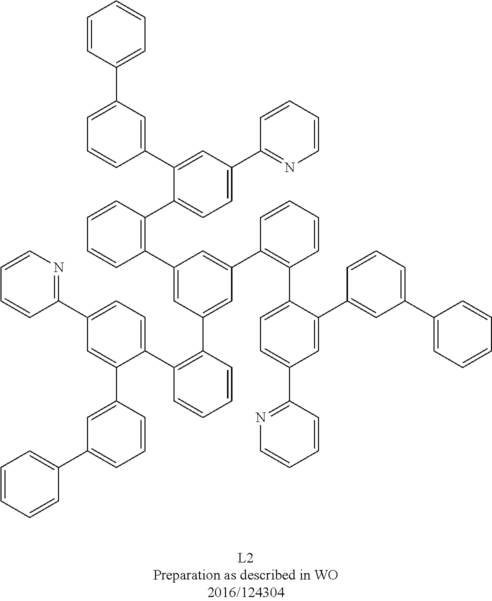 [SMILES: c1ccc(-c2cccc(-c3cc(-c4ccccn4)ccc3-c3ccccc3-c3cc(-c4ccccc4-c4ccc(-c5ccccn5)cc4-c4cccc(-c5ccccc5)c4)cc(-c4ccccc4-c4ccc(-c5ccccn5)cc4-c4cccc(-c5ccccc5)c4)c3)c2)cc1]

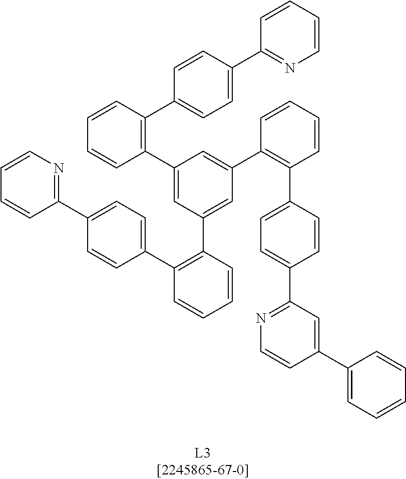 [SMILES: c1ccc(-c2ccnc(-c3ccc(-c4ccccc4-c4cc(-c5ccccc5-c5ccc(-c6ccccn6)cc5)cc(-c5ccccc5-c5ccc(-c6ccccn6)cc5)c4)cc3)c2)cc1]

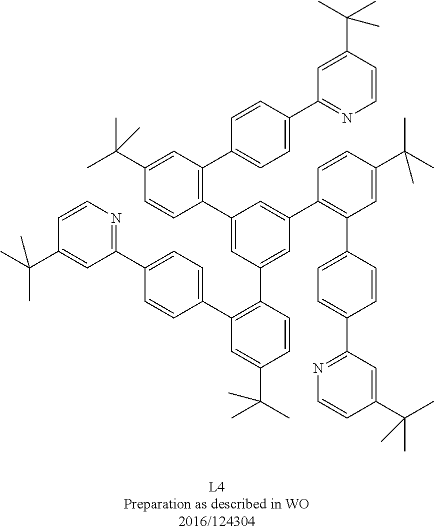 [SMILES: CC(C)(C)c1ccnc(-c2ccc(-c3cc(C(C)(C)C)ccc3-c3cc(-c4ccc(C(C)(C)C)cc4-c4ccc(-c5cc(C(C)(C)C)ccn5)cc4)cc(-c4ccc(C(C)(C)C)cc4-c4ccc(-c5cc(C(C)(C)C)ccn5)cc4)c3)cc2)c1]

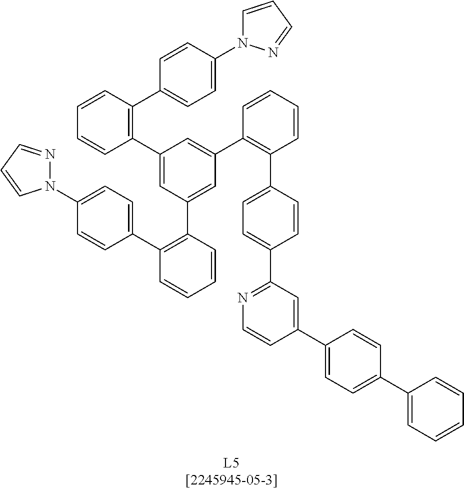 [SMILES: c1ccc(-c2ccc(-c3ccnc(-c4ccc(-c5ccccc5-c5cc(-c6ccccc6-c6ccc(-n7cccn7)cc6)cc(-c6ccccc6-c6ccc(-n7cccn7)cc6)c5)cc4)c3)cc2)cc1]

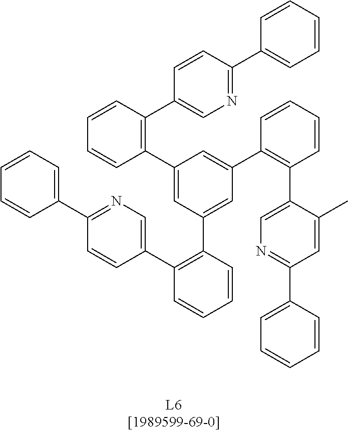 [SMILES: Cc1cc(-c2ccccc2)ncc1-c1ccccc1-c1cc(-c2ccccc2-c2ccc(-c3ccccc3)nc2)cc(-c2ccccc2-c2ccc(-c3ccccc3)nc2)c1]

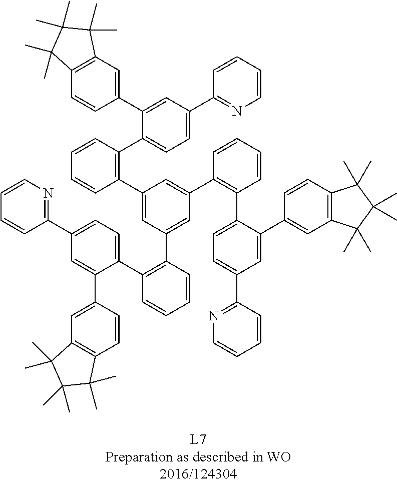 [SMILES: CC1(C)c2ccc(-c3cc(-c4ccccn4)ccc3-c3ccccc3-c3cc(-c4ccccc4-c4ccc(-c5ccccn5)cc4-c4ccc5c(c4)C(C)(C)C(C)(C)C5(C)C)cc(-c4ccccc4-c4ccc(-c5ccccn5)cc4-c4ccc5c(c4)C(C)(C)C(C)(C)C5(C)C)c3)cc2C(C)(C)C1(C)C]

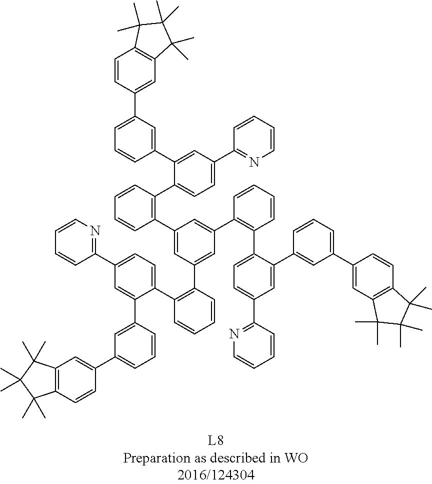

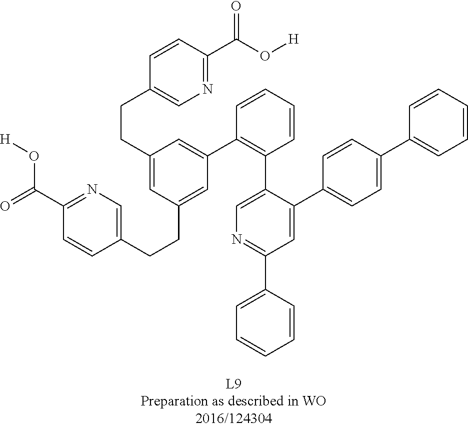 [SMILES: O=C(O)c1ccc(CCc2cc(CCc3ccc(C(=O)O)nc3)cc(-c3ccccc3-c3cnc(-c4ccccc4)cc3-c3ccc(-c4ccccc4)cc3)c2)cn1]

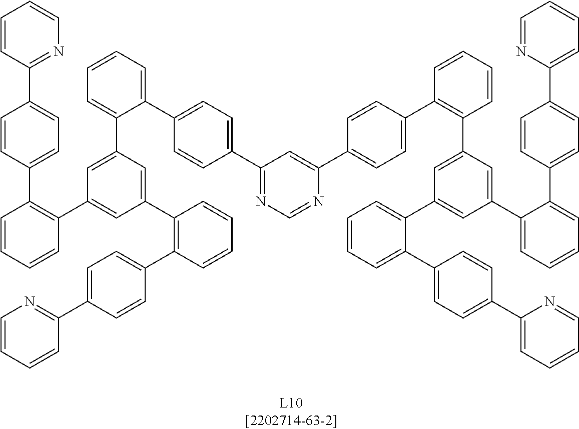 [SMILES: c1ccc(-c2ccc(-c3ccccc3-c3cc(-c4ccccc4-c4ccc(-c5ccccn5)cc4)cc(-c4ccccc4-c4ccc(-c5cc(-c6ccc(-c7ccccc7-c7cc(-c8ccccc8-c8ccc(-c9ccccn9)cc8)cc(-c8ccccc8-c8ccc(-c9ccccn9)cc8)c7)cc6)ncn5)cc4)c3)cc2)nc1]

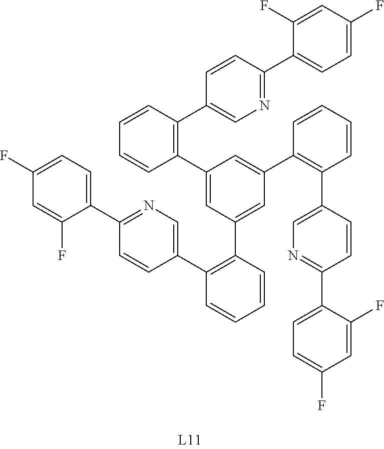 [SMILES: Fc1ccc(-c2ccc(-c3ccccc3-c3cc(-c4ccccc4-c4ccc(-c5ccc(F)cc5F)nc4)cc(-c4ccccc4-c4ccc(-c5ccc(F)cc5F)nc4)c3)cn2)c(F)c1]

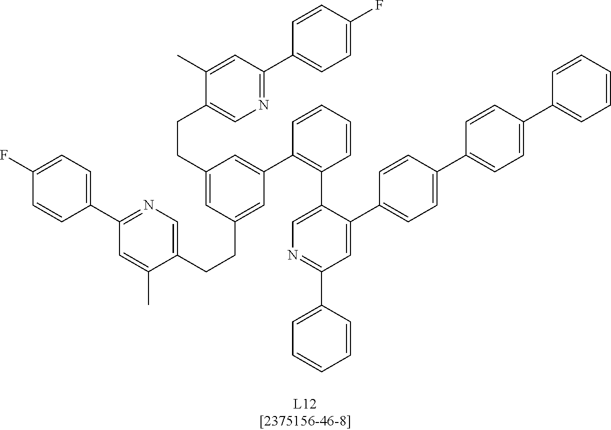 [SMILES: Cc1cc(-c2ccc(F)cc2)ncc1CCc1cc(CCc2cnc(-c3ccc(F)cc3)cc2C)cc(-c2ccccc2-c2cnc(-c3ccccc3)cc2-c2ccc(-c3ccc(-c4ccccc4)cc3)cc2)c1]

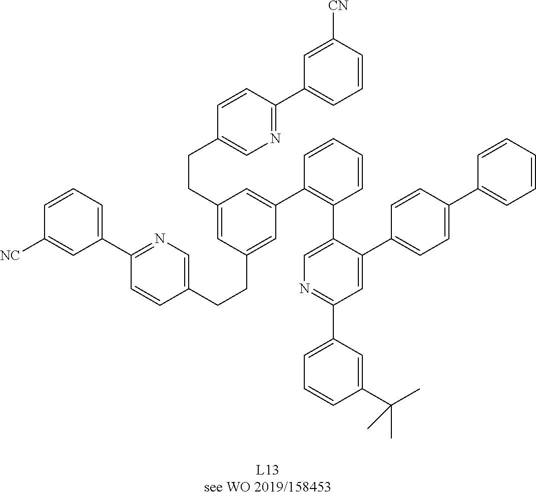 [SMILES: CC(C)(C)c1cccc(-c2cc(-c3ccc(-c4ccccc4)cc3)c(-c3ccccc3-c3cc(CCc4ccc(-c5cccc(C#N)c5)nc4)cc(CCc4ccc(-c5cccc(C#N)c5)nc4)c3)cn2)c1]

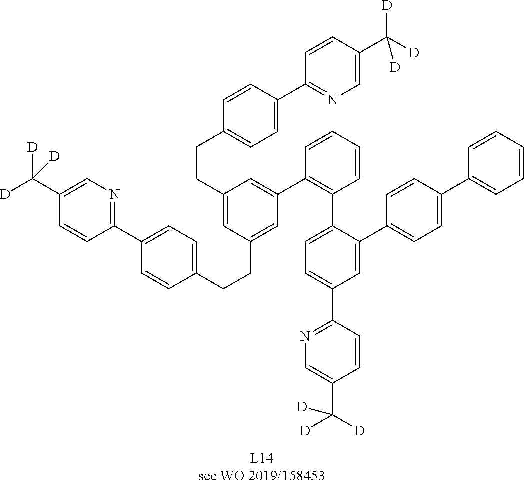 [SMILES: [2H]C([2H])([2H])c1ccc(-c2ccc(CCc3cc(CCc4ccc(-c5ccc(C([2H])([2H])[2H])cn5)cc4)cc(-c4ccccc4-c4ccc(-c5ccc(C([2H])([2H])[2H])cn5)cc4-c4ccc(-c5ccccc5)cc4)c3)cc2)nc1]

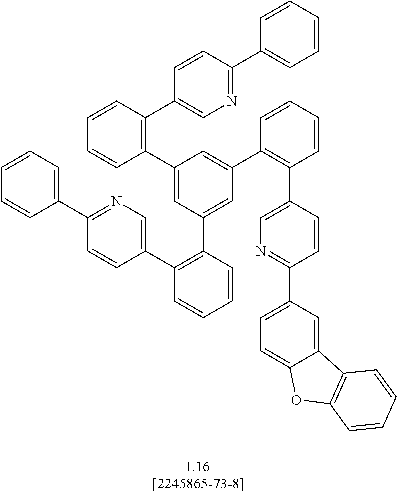 [SMILES: c1ccc(-c2ccc(-c3ccccc3-c3cc(-c4ccccc4-c4ccc(-c5ccccc5)nc4)cc(-c4ccccc4-c4ccc(-c5ccc6oc7ccccc7c6c5)nc4)c3)cn2)cc1]

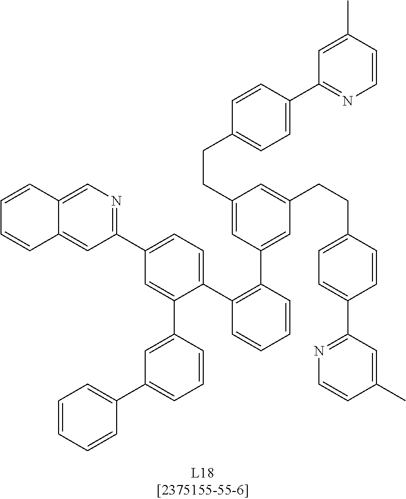 [SMILES: Cc1ccnc(-c2ccc(CCc3cc(CCc4ccc(-c5cc(C)ccn5)cc4)cc(-c4ccccc4-c4ccc(-c5cc6ccccc6cn5)cc4-c4cccc(-c5ccccc5)c4)c3)cc2)c1]

1.-16. (canceled)

17. A process for preparing a cyclometalated iridium complex by reacting an iridium compound with one or more ligands that coordinate to the iridium under cyclometalation, wherein the process is conducted in anhydrous medium in the presence of at least one carboxylic acid.

18. The process as claimed in claim 17, wherein the cyclometalated iridium complex has a structure of the formula (1), (2) or (3) 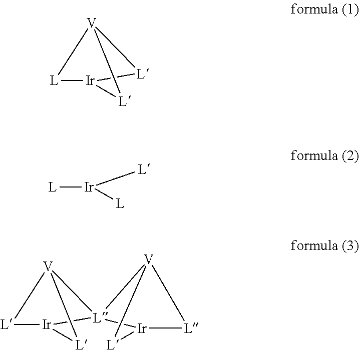
in which:
L is the same or different at each instance and is a bidentate cyclometalated ligand in formula (2) or a bidentate cyclometalated subligand in formulae (1) and (3);
L′ is the same or different at each instance and is a bidentate ligand in formula (2) or a bidentate subligand in formulae (1) and (3);
L″ is a bis(bidentate) cyclometalated subligand that coordinates to both iridium atoms;
V is the same or different at each instance and is a bridging unit which, in formula (1), joins the subligands L and L′ to one another to form a tripodal hexadentate ligand and, in formula (3), joins the subligands L′ and L″ to one another to form a dodecadentate ligand overall.

19. The process as claimed in claim 17, wherein the cyclometalated iridium complex has a structure of one of the formulae (1a), (2a) or (3a) 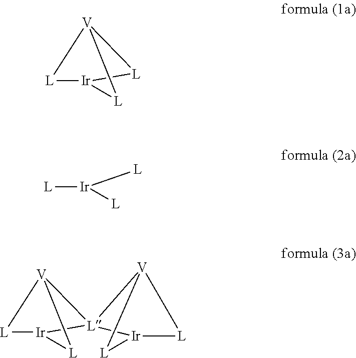
where the symbols used have the definitions given in claim 18.

20. The process as claimed in claim 17, wherein the ligands or subligands coordinate to the iridium via one carbon atom and one nitrogen atom or via two carbon atoms.

21. The process as claimed in claim 18, wherein L and/or L′ is the same or different at each instance and is a structure of formula (L-1) or (L-2) 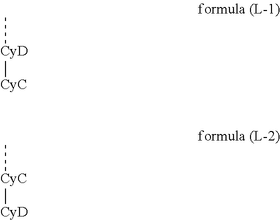
where the dotted bond represents the bond of the subligand to the bridge V in formula (1) or (3) and is absent for formula (2) and where the other symbols used are as follows:
CyC is the same or different at each instance and is a substituted or unsubstituted aryl or heteroaryl group which has 5 to 14 aromatic ring atoms and coordinates in each case to the metal via a carbon atom and which is bonded to CyD via a covalent bond;
CyD is the same or different at each instance and is a substituted or unsubstituted heteroaryl group which has 5 to 14 aromatic ring atoms and coordinates to the metal via a nitrogen atom or via a carbene carbon atom and which is bonded to CyC via a covalent bond;
at the same time, two or more of the optional substituents together may form a ring system.

22. The process as claimed in claim 18, wherein L and/or L′ is the same or different at each instance and is a structure of one of the formulae (L-1-1), (L-1-2) and (L-2-1) to (L-2-4) 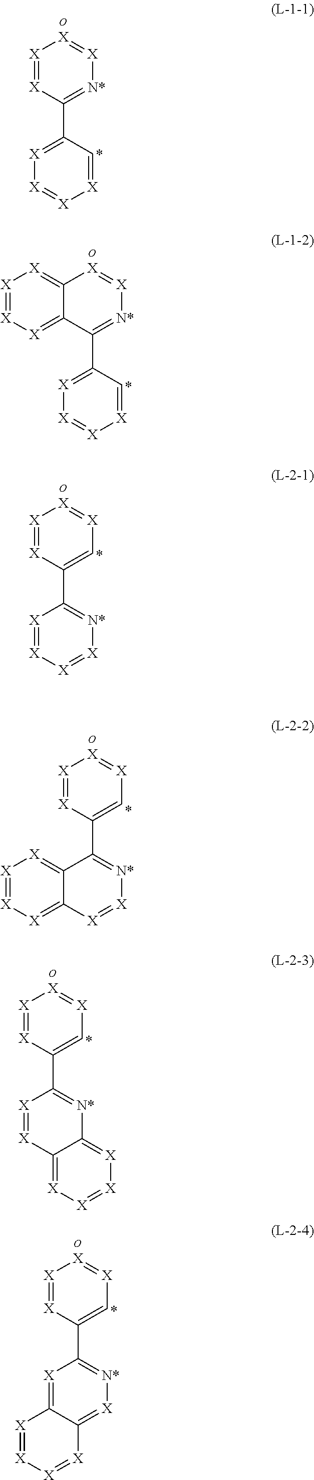
where “o” in compounds of the formula (1) or (3) represents the position of the bond to the bridge V, in which case the corresponding X is C, and where the symbols used are as follows:
X is the same or different at each instance and is CR or N, with the proviso that at most two symbols X per ring are N;
R is the same or different at each instance and is H, D, F, Cl, Br, I, N(R¹)₂, OR¹, SR¹, CN, NO₂, COOR¹, C(═O)N(R¹)₂, Si(R¹)₃, B(OR¹)₂, C(═O)R¹, P(═O)(R¹)₂, S(═O)R¹, S(═O)₂R¹, OSO₂R¹, a straight-chain alkyl group having 1 to 20 carbon atoms or an alkenyl or alkynyl group having 2 to 20 carbon atoms or a branched or cyclic alkyl group having 3 to 20 carbon atoms, where the alkyl, alkenyl or alkynyl group may in each case be substituted by one or more R¹ radicals and where one or more nonadjacent CH₂ groups may be replaced by Si(R¹)₂, C═O, NR¹, O, S or CONR¹, or an aromatic or heteroaromatic ring system which has 5 to 40 aromatic ring atoms and may be substituted in each case by one or more nonaromatic R¹ radicals; at the same time, two R radicals together may also form a ring system;
R¹ is the same or different at each instance and is H, D, F, Cl, Br, I, N(R²)₂, OR², SR², CN, NO₂, Si(R²)₃, B(OR²)₂, C(═O)R², P(═O)(R²)₂, S(═O)R², S(═O)₂R², OSO₂R², a straight-chain alkyl group having 1 to 20 carbon atoms or an alkenyl or alkynyl group having 2 to 20 carbon atoms or a branched or cyclic alkyl group having 3 to 20 carbon atoms, where the alkyl, alkenyl or alkynyl group may in each case be substituted by one or more R² radicals and where one or more nonadjacent CH₂ groups may be replaced by Si(R²)₂, C═O, NR², O, S or CONR², or an aromatic or heteroaromatic ring system which has 5 to 40 aromatic ring atoms and may be substituted in each case by one or more R² radicals; at the same time, two or more R¹ radicals together may form a ring system;
R² is the same or different at each instance and is H, D, F or an aliphatic organic radical, in which one or more hydrogen atoms may also be replaced by F.

23. The process as claimed in claim 18, wherein exactly one of the ligands or subligands L or L′ is a ligand or subligand of the formula (L-39) that coordinates to the iridium via the two D groups and, when the complex is of the formula (1) or (3), is bonded to V via the position identified by “o”, in which case the corresponding X is C, 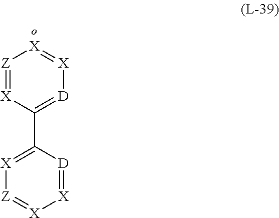
where:
D is C or N, with the proviso that one D is C and the other D is N;
X is the same or different at each instance and is CR or N;
Z is CR′, CR or N, with the proviso that exactly one Z is CR′ and the other Z is CR or N; where a maximum of one symbol X or Z per cycle is N;
R′ is a group of the formula (17) or (18) 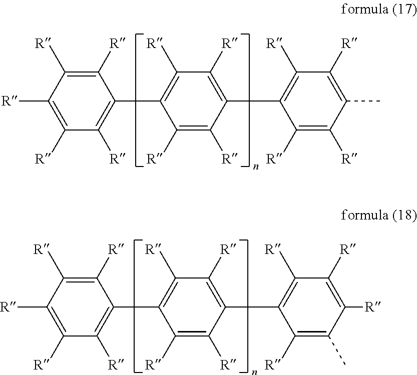
where the dotted bond indicates the attachment of the group;
R″ is the same or different at each instance and is H, D, F, CN, a straight-chain alkyl group having 1 to 10 carbon atoms in which one or more hydrogen atoms may also be replaced by D or F, or a branched or cyclic alkyl group having 3 to 10 carbon atoms in which one or more hydrogen atoms may also be replaced by D or F, or an alkenyl group having 2 to 10 carbon atoms in which one or more hydrogen atoms may also be replaced by D or F; at the same time, two adjacent R″ radicals or two R″ radicals on adjacent phenyl groups together may also form a ring system; or two R″ on adjacent phenyl groups together are a group selected from C(R¹)₂, NR¹, O and S, such that the two phenyl rings together with the bridging group are a carbazole, dibenzofuran or dibenzothiophene, and the further R″ are as defined above;
n is 0, 1, 2, 3, 4 or 5.

24. The process as claimed in claim 18, wherein the subligand L″ has a structure of the formula (19) or (20) 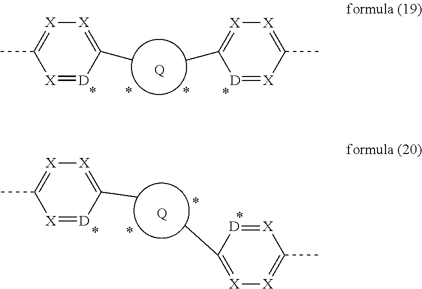
where X has the definitions given in claim 22, the dotted bond indicates the bond to V, * denotes the coordination to the iridium atom, and in addition:
D is the same or different at each instance and is C or N;
Q in formula (19) is a group of one of the formulae (Q-1) to (Q-3), and in formula (20) is a group of one of the formulae (Q-4) to (Q-15), 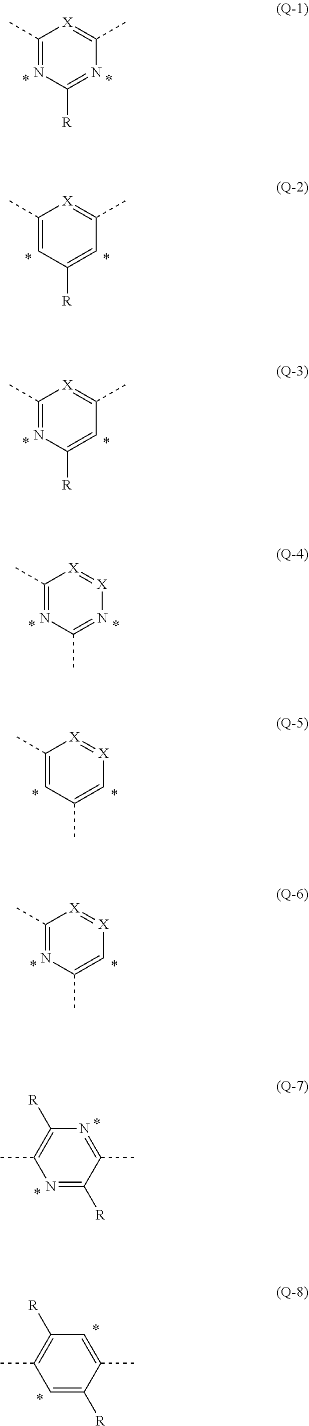 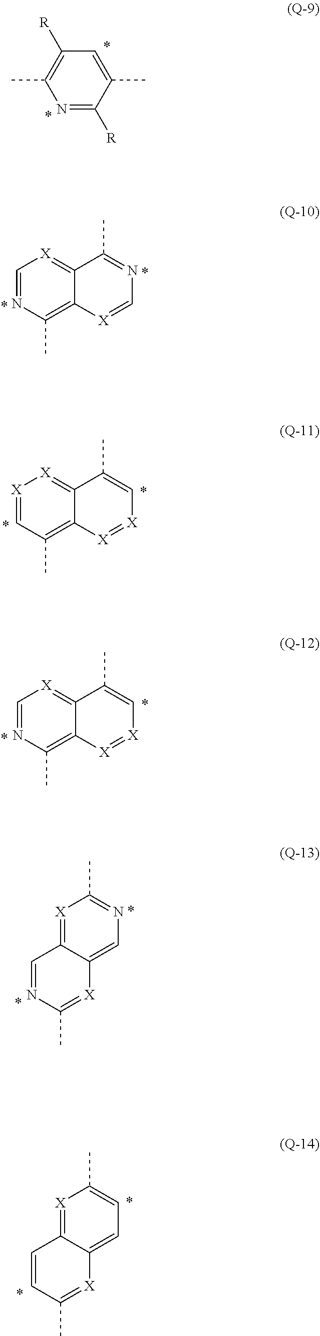 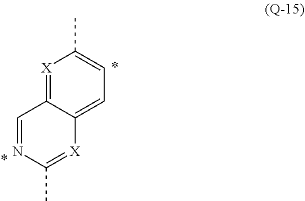
where the dotted bond in each case indicates the linkage within the formula (19) or (20), * marks the position at which this group coordinates to the iridium atom, and X has the definitions given in claim 18.

25. The process as claimed in claim 18, wherein L′ is the same as or different to L, or in that L′ is selected from the group of the acetylacetonates, the picolinic acid derivatives, the pyrazolylborates or the hydroxyquinolinates.

26. The process as claimed in claim 17, wherein V represents a group of the formula (21), where the dotted bonds represent the position of the linkage of the subligands L and L′, 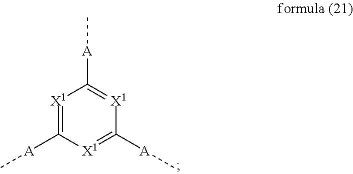
where:
X¹ is the same or different at each instance and is CR or N;
X² is the same or different at each instance and is CR or N;
A is the same or different at each instance and is CR₂-CR₂, CR₂—O, CR₂—NR, C(═O)—O, C(═O)—NR or a group of the following formula (22): 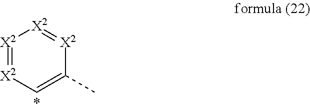
where the dotted bond in each case represents the position of the bond of the bidentate subligands L or L′ to this structure, * represents the position of the linkage of the unit of the formula (21) to the central trivalent aryl or heteroaryl group.

27. The process as claimed in claim 17, wherein the iridium reactant used is an iridium halide, an iridium carboxylate, a COD-iridium(I) compound, an iridium ketoketonate or a compound of one of the formulae (34) to (39) 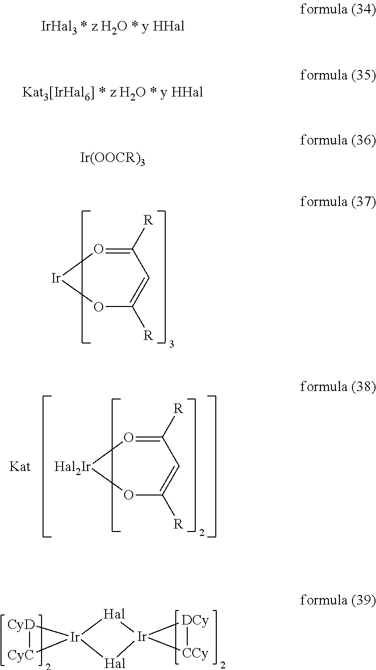
where R, CyC and CyD have the definitions given in claim 21, and the further symbols and indices used are as follows:
Hal is the same or different at each instance and is F, Cl, Br or I;
Kat is the same or different at each instance and is an alkali metal cation, an ammonium cation, a tetraalkylammonium cation having 4 to 40 carbon atoms or a tetraalkylphosphonium cation having 4 to 40 carbon atoms;
z is 0 to 100;
y is 0 to 100.

28. The process as claimed in claim 17, wherein the carboxylic acid has a structure of the formula R⁴—COOH or HOOC—R⁵—COOH, where R⁴ is selected from the group consisting of a straight-chain alkyl group having 1 to 20 carbon atoms or a branched or cyclic alkyl group having 3 to 20 carbon atoms, where the alkyl group in each case may be substituted by one or more R¹ radicals, or an alkenyl or alkyl group which has 2 to 20 carbon atoms and may be substituted by one or more R¹ radicals, an aromatic or heteroaromatic ring system which has 5 to 40 aromatic ring atoms and may be substituted in each case by one or more nonaromatic R¹ radicals, or an aralkyl or heteroaralkyl group which has 5 to 20 aromatic ring atoms and may be substituted in each case by one or more R¹ radicals, and where R⁵ is selected from the group consisting of a straight-chain alkylene group having 1 to 20 carbon atoms or a branched or cyclic alkylene group having 3 to 20 carbon atoms, where the alkylene group in each case may be substituted by one or more R¹ radicals, or an alkenyl or alkynyl group which has 2 to 20 carbon atoms and may be substituted by one or more R¹ radicals, a bivalent aromatic or heteroaromatic ring system which has 5 to 40 aromatic ring atoms and may be substituted in each case by one or more nonaromatic R¹ radicals, or a bivalent aralkyl or heteroaralkyl group which has 5 to 20 aromatic ring atoms and may be substituted in each case by one or more R¹ radicals.

29. The process as claimed in claim 17, wherein the carboxylic acid used is acetic acid, propionic acid, pivalic acid, benzoic acid, salicylic acid, phenylacetic acid, adipic acid or mixtures thereof.

30. The process as claimed in claim 17, wherein, when a hydrate is used as iridium reactant, a water scavenger is added, selected from the group consisting of a carboxylic anhydride, a carbonyl halide, a trialkyl orthocarboxylate, a carbodiimide, phosphorus pentoxide, thionyl chloride and phosphoryl chloride.

31. The process as claimed in claim 17, wherein, when a halide is used as iridium reactant, a halide scavenger is added, selected from the group consisting of an alkali metal, alkaline earth metal, ammonium or zinc salt of a carboxylic acid.

32. The process as claimed in claim 17, wherein a chiral, enantiomerically pure carboxylic acid is used.
